(19) United States
(12) Patent Application Publication
(10) Pub. No.: US 2024/0267900 A1
(43) Pub. Date: Aug. 8, 2024

(54) SYSTEM, METHOD, AND DEVICE FOR SUPPORTING COMMUNICATION AND SENSING

(71) Applicant: SAMSUNG ELECTRONICS CO., LTD., Suwon-si (KR)

(72) Inventors: Gibum KIM, Suwon-si (KR); Kwonjong LEE, Suwon-si (KR); Sangwon JUNG, Suwon-si (KR)

(21) Appl. No.: 18/434,705

(22) Filed: Feb. 6, 2024

(30) Foreign Application Priority Data
Feb. 8, 2023 (KR) 10-2023-0016872

(51) Int. Cl. H04W 72/0453; G01S 7/00; H04W 72/11

(52) U.S. Cl. CPC H04W 72/0453; G01S 7/006; H04W 72/11

(57) ABSTRACT

The disclosure relates to a 5G or 6G communication system for supporting a higher data transmission rate than 4G communication systems such as LTE systems. A method by a base station in a wireless communication system may comprise transmitting, to a user equipment (UE), sensing configuration information for a sensing operation; transmitting a first sensing signal for the sensing operation based on the sensing configuration information; and receiving a second sensing signal reflected from a target based on the sensing configuration information and obtaining sensing data based on the second sensing signal, wherein the sensing configuration information includes resource allocation information for the sensing operation.

### CROSS-REFERENCE TO RELATED APPLICATION

This application is based on and claims priority under 35 U.S.C. § 119 to Korean Patent Application No. 10-2023-0016872, which was filed in the Korean Intellectual Property Office on Feb. 8, 2023, the entire disclosure of which is incorporated herein by reference.

### BACKGROUND

### 1. Field

The disclosure relates to a system, method, and device for supporting communication and sensing in a wireless communication system.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### SUMMARY

This disclosure relates to a method and device for providing monostatic sensing in a system supporting communication and sensing.

A method by a base station in a wireless communication system may comprise transmitting, to a user equipment (UE), sensing configuration information for a sensing operation; transmitting a first sensing signal for the sensing operation based on the sensing configuration information; and receiving a second sensing signal reflected from a target based on the sensing configuration information and obtaining sensing data based on the second sensing signal, wherein the sensing configuration information includes resource allocation information for the sensing operation.

A method by a user equipment (UE) in a wireless communication system may comprise receiving, from a base station, sensing configuration information for a sensing operation; and performing a communication operation based on the sensing configuration information, wherein the sensing configuration information includes information of a first sensing signal and a second sensing signal for the sensing operation, the second sensing signal being reflected from a target based on the sensing configuration information and the first sensing signal, and wherein the sensing configuration information includes resource allocation information for the sensing operation.

A base station in a wireless communication system may comprise a transceiver; and at least one processor coupled to the transceiver and configured to: transmit, to a user equipment (UE), sensing configuration information for a sensing operation; transmit a first sensing signal for the sensing operation based on the sensing configuration information; and receive a second sensing signal reflected from a target based on the sensing configuration information and obtaining sensing data based on the second sensing signal, wherein the sensing configuration information includes resource allocation information for the sensing operation.

A user equipment (UE) in a wireless communication system may comprise a transceiver; and at least one processor coupled to the transceiver and configured to: receive, from a base station, sensing configuration information for a sensing operation; and perform a communication operation based on the sensing configuration information, wherein the sensing configuration information includes information of a first sensing signal and a second sensing signal for the sensing operation, the second sensing signal being reflected from a target based on the sensing configuration information and the first sensing signal, and wherein the sensing configuration information includes resource allocation information for the sensing operation.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates an example of a communication system according to an embodiment of the present disclosure;

FIG. 2A illustrates an example of a basic structure of a time-frequency domain in a wireless communication system according to an embodiment of the present disclosure;

FIG. 2B illustrates an example of a structures of a frame, a subframe, and a slot in a wireless communication system according to an embodiment of the present disclosure;

FIG. 3 illustrates an example of an JCAS system according to an embodiment of the present disclosure;

FIG. 4 illustrates an example of a sensing procedure in a JCAS system according to an embodiment of the present disclosure;

FIGS. 5A and 5B illustrate examples of resource allocation for sensing according to an embodiment of the present disclosure;

FIG. 6 illustrates an example of a JCAS-enabled device using different waveforms for sensing and communication according to an embodiment of the present disclosure;

FIGS. 7A and 7B are block illustrate examples of a JCAS-enabled device using the same waveform for sensing and communication according to an embodiment of the present disclosure;

FIG. 8A illustrates an example of sensing configuration information according to an embodiment of the present disclosure;

FIG. 8B illustrates an example of sensing configuration information according to an embodiment of the present disclosure;

FIG. 8C illustrates an example of sensing configuration information according to an embodiment of the present disclosure;

FIG. 9A illustrates an example of sensing resource allocation according to an embodiment of the present disclosure;

FIG. 9B illustrates an example of sensing resource allocation according to an embodiment of the present disclosure;

FIG. 10 illustrates a sensing procedure according to a periodic transmission mode according to an embodiment of the present disclosure;

FIG. 11 illustrates an example of a sensing procedure according to a semi-persistent transmission mode according to an embodiment of the present disclosure;

FIG. 12 illustrates an example of sensing resource allocation according to a semi-persistent transmission mode according to an embodiment of the present disclosure;

FIG. 13 illustrates an example of a sensing procedure according to an aperiodic transmission mode according to an embodiment of the present disclosure;

FIG. 14 illustrates an example of sensing resource allocation according to an aperiodic transmission mode according to an embodiment of the present disclosure;

FIG. 15 illustrates an example of a sensing configuration procedure according to an embodiment of the present disclosure;

FIG. 16A illustrates an example of a sensing configuration procedure using SI according to an embodiment of the present disclosure;

FIG. 16B illustrates an example of a sensing configuration procedure using SI according to an embodiment of the present disclosure;

FIG. 17 illustrates an example of a DL communication operation of a UE in a JCAS system according to an embodiment of the present disclosure;

FIG. 18 illustrates an example of a DL communication operation of a UE in a JCAS system according to an embodiment of the present disclosure;

FIG. 19 illustrates an example of a procedure in which a UE performs channel estimation using a sensing sequence in a JCAS system according to an embodiment of the present disclosure;

FIG. 20 illustrates an example of a UL communication operation of a UE in a JCAS system according to an embodiment of the present disclosure;

FIG. 21 illustrates an example of configuration of a UE according to an embodiment of the present disclosure; and

FIG. 22 illustrates an example of configuration of a base station according to an embodiment of the present disclosure.

### DETAILED DESCRIPTION

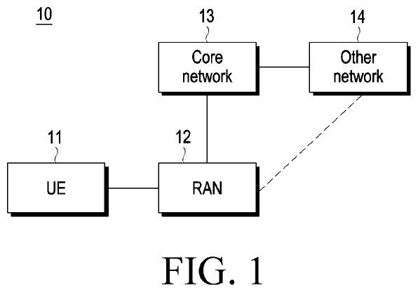

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing embodiments, the description of technologies that are known in the art and are not directly related to the disclosure is omitted. This is for further clarifying the gist of the disclosure without making it unclear.

For the same reasons, some elements may be exaggerated or schematically shown. The size of each element does not necessarily to reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification. When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, a “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “ . . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

For ease of description, some of the terms or names defined in the 3rd generation partnership project (3GPP) standards (standards for 5G, new radio (NR), long-term evolution (LTE), or similar systems) may be used. However, the disclosure is not limited by such terms and names and may be likewise applicable to systems conforming to other standards. Further, the disclosure is not limited to the terms used in the following embodiments, and the terms may be replaced with other terms denoting objects with equivalent technical meanings.

### [Communication System]

FIG. 1 illustrates an example of a communication system according to an embodiment of the present disclosure.

Referring to FIG. 1, a communication system 10 may include a user equipment (UE) 11, a radio access network (RAN) 12, a core network (CN) 13, and/or another network 14.

The UE 11 may be a user device capable of performing communication functions. For example, the UE 11 may include a user equipment (UE), a mobile station (MS), a wireless transmit/receive unit (WTRU), a cellular phone, a smartphone, a machine type communication (MTC) device, a computer, a wireless sensor, a vehicle, an IoT device, and/or other electronic devices capable of performing communication functions. The UE 11 may communicate with other UEs or with one or more network nodes within the radio access network 12.

The radio access network 12 is a next-generation radio access network (e.g., 6G, or later radio access network, etc.) or a legacy radio access network (e.g., 5G (NR), 4G (e.g., LTE), 3G, etc.). The radio access network 12 (or network node(s) within the radio access network 12) may communicate with one or more network nodes in the core network 13 and the UE 11. Further, the radio access network 12 may optionally communicate with another network 13.

The radio access network 12 may include one or more network nodes (e.g., base station (BS)). The base station is an entity that performs resource allocation of the UE 11, and may be a radio base station, a nodeB, an evolved node B (eNodeB or eNB), a next-generation node B (gNodeB or gNB), a radio access unit, a network node, a network device, a node on a network, a base station controller, a transmission point (TP), an access point (AP), a relay station, a base band unit (BBU), a remote radio unit (RU), a remote radio head (RH), or a transmit and receive point (TRP). As an embodiment, the base station may be divided into a central unit (CU) and at least one distribute unit (DU) controlled/managed by the CU. In the disclosure, downlink (DL) refers to a wireless transmission path of signal transmitted from the base station to the UE 11, and uplink (UL) refers to a wireless transmission path of signal transmitted from the UE 11 to the base station. In the disclosure, the operation of the base station itself or a divided component (e.g., CU or DU) of the base station may be understood of the operation of the base station.

The core network 13 is part of the communication system 10 and may be dependent on or independent from the radio access technology (RAT) used in the communication system 10.

According to an embodiment, the core network 13 may be a 5G core network (5GC). According to an embodiment, the 5GC may include an access and mobility management function (AMF) for managing access and mobility of the UE 11, a session management function (SMF) for managing a packet data unit (PDU) session of the UE 11, a user plane function (UPF) connected to a data network (DN) to perform a data transfer role, a policy control function (PCF) for providing a policy control function, a user data management (UDM) for providing data management functions such as subscriber data and policy control data, a unified data repository (UDR) for storing data of various network functions (NFs), a network slice selection function (NSSF) for selecting network slice instances for servicing the UE 11, and/or a network slice admission control function (NSACF) for monitoring and controlling the number of registered UEs and PDU sessions.

According to an embodiment, the core network 13 may be a core network (e.g., 6G core network, 4G (LTE) core network, etc.) other than 5GC. In this case, the core network 13 may include a network function (node) that performs the same or similar functions as the network functions (nodes) of the 5GC described above.

The other network 14 is a network other than the core network 13 and may communicate with at least one network node within the core network 13. Further, the other network 14 may communicate with at least one network node of the radio access network 12. As an embodiment, the other network 14 may be a data network, a network providing an application function (AF) that provides an application service, or an Internet network.

### [Time-Frequency Resource]

The frame structure of a wireless communication system (e.g., a 5G system) is described below in more detail with reference to the drawings.

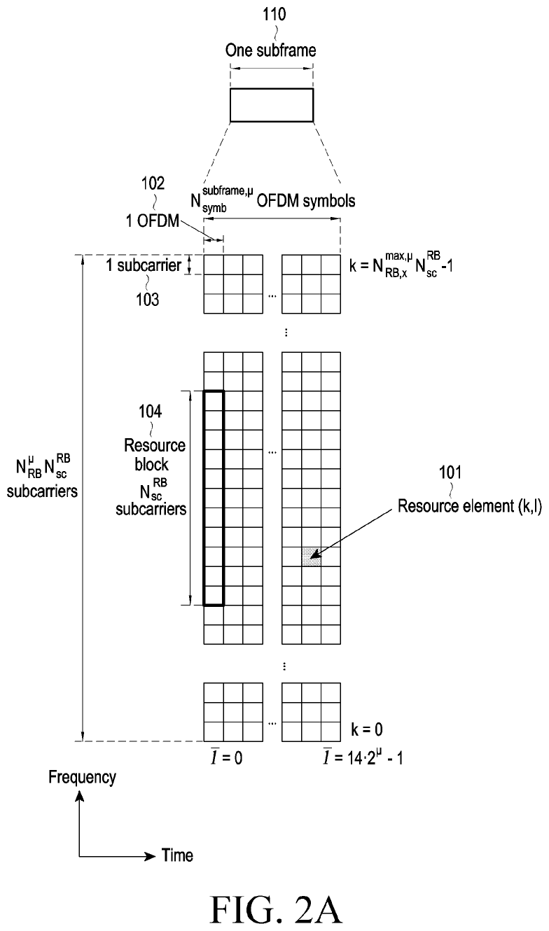

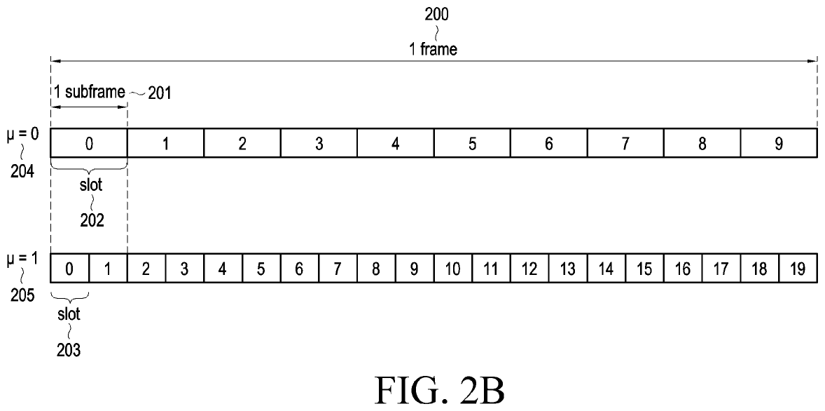

FIG. 2A illustrates an example of a structure of a time-frequency domain in a wireless communication system according to an embodiment of the present disclosure.

In FIG. 2A, the horizontal axis refers to the time domain, and the vertical axis refers to the frequency domain. A basic unit of a resource in the time and frequency domain is a resource element (RE) 101, which may be defined by one orthogonal frequency division multiplexing (OFDM) symbol 102 on the time axis, and by one subcarrier 103 on the frequency axis. In the frequency domain, N_{μ}^{RB}(e.g., 12) consecutive REs may constitute one resource block (RB) 104. In FIG. 2A, N_{symb}^{subframe, μ} is the number of OFDM symbols per subframe 110 for subcarrier spacing setting (μ).

FIG. 2B illustrates an example of a structures of a frame, a subframe, and a slot in a wireless communication system according to an embodiment of the present disclosure.

FIG. 2B illustrates example structures of a frame 200, a subframe 201, and a slot 202. One frame 200 may be defined as 10 ms. One subframe 201 may be defined as 1 ms, and thus, one frame 200 may consist of a total of 10 subframes 201. One slot 202 or 203 may be defined as 14 OFDM symbols (that is, the number (N_{symb}^{slot}) of symbols per slot=14). One subframe 201 may be composed of one or more slots 202 and 203, and the number of slots 202 and 203 per subframe 201 may differ depending on μ (204 or 205), which is a set value for the subcarrier spacing. FIG. 2B illustrates an example in which the subcarrier spacing setting value μ=0 (204) and an example in which the subcarrier spacing setting value μ=1 (205). When μ=0 (204), one subframe 201 may consist of one slot 202, and when μ=1 (205), one subframe 201 may consist of two slots (203). In other words, according to the set subcarrier spacing value μ, the number (Nₛₗₒₜ^{subframe,μ}) of slots per subframe may vary, and accordingly, the number (Nₛₗₒₜ^{frame,μ}) of slots per frame may differ. According to each subcarrier spacing μ, Nₛₗₒₜ^{subframe,μ} and Nₛₗₒₜ^{frame,μ} may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Joint Communications and Sensing (JCAS) System/Network]

Below, a system that performs both communication and sensing is described. For example, a system that integrates communication and sensing functions into a single system is described. The system that performs both communication and sensing may be referred to as a JCAS system, but the term denoting the system is not limited thereto. For example, the JCAS system may be referred to by other terms, such as an integrated sensing and communication (ISAC) system or a joint sensing and communications (JSAC) system.

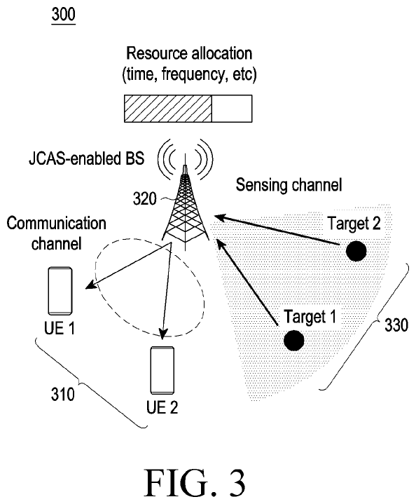

FIG. 3 illustrates an example of JCAS system according to an embodiment of the present disclosure.

The JCAS system 300 of FIG. 3 may not only provide a communication function provided by the communication system 10 of FIG. 1 but may also provide an additional function for providing sensing and an additional function for providing communication and sensing together.

Referring to FIG. 3, the JCAS system 300 may include at least one UE 310 (e.g., UE1, UE2, etc.), at least one TRP/base station 320, and/or at least one target 330 (e.g., target 1, target 2, etc.).

The UE 310 may be an electronic device supporting a communication function and/or a sensing function. As an embodiment, the UE 310 may include a UE, an MS, a wireless transmit/receive unit, a cellular phone, a smartphone, an MTC device, a computer, a wireless sensor, a vehicle, an IoT device, and/or an electronic device capable of performing other communication functions and/or sensing functions.

The UE 310 according to an embodiment may communicate with another UE or may communicate with a network (JCAS network) of the JCAS system 300 using a communication function. For example, like, e.g., the UE 11 of FIG. 1, the UE 310 may communicate with another UE or may communicate with one or more network nodes (e.g., the base station 320) in the radio access network of the JCAS system 300. For example, the UE 310 may receive a communication signal (DL signal) from the base station 320 through a communication channel and may transmit the communication signal (UL signal) to the base station 320.

The UE 310 according to an embodiment may further support a sensing function. For example, the UE 310 may receive a sensing signal from the base station 320 through a sensing channel and may perform a sensing operation based on the sensing signal. For example, the UE 310 may transmit the sensing signal through the sensing channel. For example, the UE 310 may receive a reflection of the sensing signal transmitted from the base station 320 or another UE through the sensing channel and may perform a sensing operation based on the received reflection (reflection signal).

According to an embodiment, the UE 310 may be a device registered in the JCAS network.

The base station 320 may be a network node that integrates and supports communication and sensing functions. The base station 320 that integrates and supports such communication and sensing functions may be referred to as a JCAS-enabled BS, a JSAC-enabled BS, or an ISAC-enabled BS. In an embodiment, the base station 320 is an entity performing resource allocation for communication and sensing of the UE 310 and may be a wireless base station, a NodeB, an eNB, a radio access unit, a network node, a network device, a node on a network, a base station controller, a TP, an AP, a relay station, a BBU, an RRU, an RRH, a CU, a DU, or a TRP.

According to an embodiment, the base station 320 may communicate with the UE 310 or may communicate with a core network or another network of the JCAS system 300 using a communication function. For example, the base station 320 may transmit a communication signal (DL signal) to the UE 310 through a communication channel and may receive the communication signal (UL signal) from the UE 310. The core network of the JCAS system 300 may include at least one network node for supporting a communication function (service) and a sensing function (service). According to an embodiment, the core network of the JCAS system 300 may be the 5G core network 5GC. As an embodiment, the 5GC may include an AMF, an SMF, a UPF, a PCF, a UDM, a UDR, an NSSF, and/or an NSACF, and the description of each NF may refer to the description of FIG. 1. According to an embodiment, the core network of the JCAS system 300 may be a core network (e.g., a 6G core network, a 4G (LTE) core network, etc.) other than 5GC. In this case, the corresponding core network may include a network function (node) that performs the function identical or similar to those of the network functions (nodes) of the 5GC described above.

The base station 320 according to an embodiment may support a sensing function. For example, the base station 320 may transmit information (e.g., resource allocation information (e.g., time resource allocation information and/or frequency resource allocation information) of the sensing signal) required to perform sensing. For example, the base station 320 may transmit a sensing signal through a sensing channel. For example, the base station 320 may receive a reflection of the sensing signal transmitted from itself, another base station, or the UE 310 through a sensing channel, and may perform a sensing operation based on the received reflection (reflection signal).

The target 330 is an entity to be sensed and may be a UE (e.g., the UE 11 of FIG. 1 or the UE 310 of FIG. 3) having a communication function or an object (e.g., a person, a thing, a building, a vehicle, etc.) not having a communication function. The base station 320 (or the UE 310) may transmit a sensing signal to the target 330 through a sensing channel. The base station 320 (or the UE 310) may receive a reflection (reflection signal) reflected from the target 330 and may perform a sensing operation based on the reflection signal. In this case, the reflection signal may be a reflection of a sensing signal transmitted by itself or a reflection of a sensing signal transmitted by another device (e.g., another base station or another UE).

According to an embodiment, sensing may be performed by, e.g., an individual device such as a single base station 320 or a single UE 310 (monostatic case). According to an embodiment, sensing may be performed jointly by a plurality of devices, e.g., a base station pair, a UE pair, or a UE/base station pair (bistatic case). According to an embodiment, sensing may be performed by an individual device and/or a combination of a plurality of devices jointly performing sensing (multistatic case).

According to an embodiment, the sensing signal (reflection signal) reflected from the target 330 may be used to generate sensing data for the target 330.

The sensing data may include information (sensing information) that may be derived from the reflection signal. According to an embodiment, the sensing information may include information that may be measured from a signal strength, a delay, a timing, an angle of arrival (AoA), a time of flight (ToF), and/or other reflection signals.

Further, the sensing data may further include a description of the sensing data, information for identifying a purpose of sensing, information for identifying a source of sensing, and/or information (e.g., target identification information, target location information, etc.) on a target associated with the sensing data.

According to an embodiment, sensing data (or sensing information) may be used to generate a sensing result for the target. According to an embodiment, the sensing result may include information about a distance, a location, and/or a speed (Doppler) with respect to the target.
Table 2 shows an example of an element and a formula for determining a distance and a speed through sensing.

TABLE 2

| Metric | Category | Determined by | Formula |
|---|---|---|---|
| Range | Maximum | FFT size | Rₘₐₓ = Rᵣₑₛ · N_{FFT} |
| | Resolution | Bandwidth | Rᵣₑₛ = c/(2 · BW) |
| Doppler | Maximum | Interval between adjacent | vₘₐₓ = λ/4Tₛₑₙₛ^{sym} |
| | | OFDM symbol | |
| | Resolution | Accumulated duration of | vᵣₑₛ = λ/2Tₛₑₙₛ^{accum} |
| | | OFDM symbols for Doppler | |
| | | processing | |

Referring to Table 2, a resolution (Rres) of a range that may be measured through a sensing operation may be determined based on a bandwidth (BW). The maximum range (max range) of the range that may be measured through the sensing operation may be determined based on the resolution (Rres) and/or the FFT size (NFFT). Referring to Equation 2 of Table 2, as the bandwidth BW increases, the maximum range/range resolution may be enhanced. Meanwhile, sensing processing requires a continuous frequency/bandwidth due to its characteristics. Accordingly, the maximum continuous frequency/bandwidth available in the base station 320 needs to be used for sensing.

Referring to Table 2, the maximum value of the speed (Doppler) that may be measured through a sensing operation may be determined based on the interval (Tₛₑₙₛ^{sym}) between adjacent OFDM symbols allocated for sensing. For example, as the interval (Tₛₑₙₛ^{sym}) decreases, the maximum speed (maximum Doppler) may be enhanced. The resolution of the speed that may be measured through the sensing operation may be determined based on the duration (Tₛₑₙₛ^{accum}) of the accumulated OFDM symbols for Doppler processing. Referring to the equation in Table 2, as the duration (Tₛₑₙₛ^{accum}) increases, the speed resolution (Doppler resolution) may be enhanced. Therefore, considering the Doppler requirements, an appropriate sensing signal transmission period needs to be set. As an embodiment, the duration (Tₛₑₙₛ^{accum}) may be associated with the number of symbols for Doppler processing.

According to an embodiment, the processing chain (e.g., PHY processing chain) for communication (communication signal) may be the same as, or different from, the processing chain for sensing (sensing signal). For example, the same modulation parameter, coding parameter, and/or waveform parameter may be used for communication and sensing. For example, different modulation parameters, coding parameters and/or waveform parameters may be used for communication and sensing.

According to an embodiment, the RAT for communication may be the same as, or different from, the RAT for sensing.

According to an embodiment, the same carrier (frequency carrier) or different carriers may be used for communication and sensing.

According to an embodiment, different signal formats (structures) may be used for communication and sensing. For example, the sensing signal structure may be different from the communication signal structure.

According to an embodiment, separate PHY channels or a common PHY channel may be used for communication and sensing. For example, separate PHY control channels (e.g., PDCCH and PUCCH) and separate PHY data channels (e.g., PDSCH and PUSCH) may be used for communication and sensing, respectively. For example, a common PHY control channel (e.g., PDCCH or PUCCH) may be used for communication and sensing. When a common PHY control channel is used for communication and sensing, the PHY data channel (e.g., PDSCH or PUSCH) may be used separately or commonly used for communication and sensing.

### [Sensing Procedure]

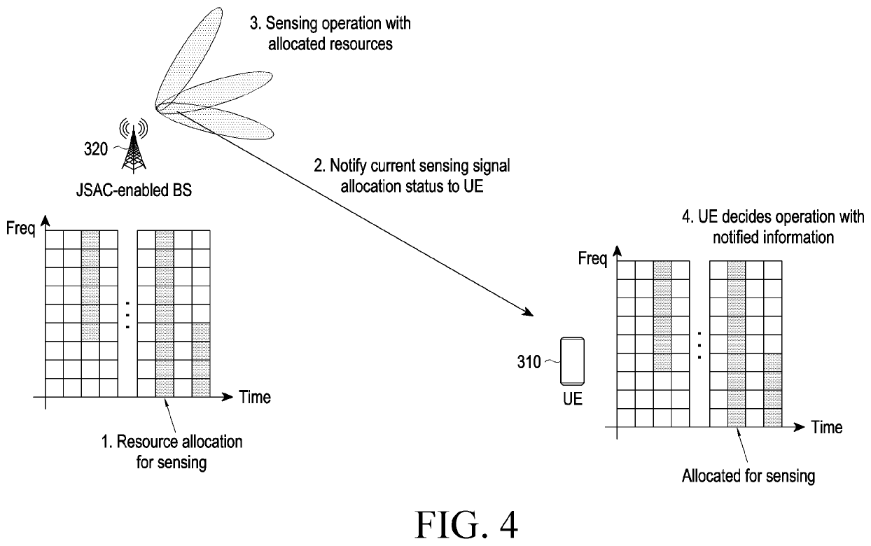

FIG. 4 illustrates an example of a sensing procedure in a JCAS system according to an embodiment of the present disclosure.

In the case of the JCAS system, in order to perform sensing together with communication, the base station 320 needs to allocate a resource for sensing and provide a notification of the allocated resource to the UE 310. In this case, unlike in a general communication system (e.g., the communication system 10 of FIG. 1), the UE 310 needs to perform an operation different from the existing communication operation in a resource area (or section) for notified sensing.

Hereinafter, an exemplary sensing procedure in a JCAS system is described with reference to FIG. 4.

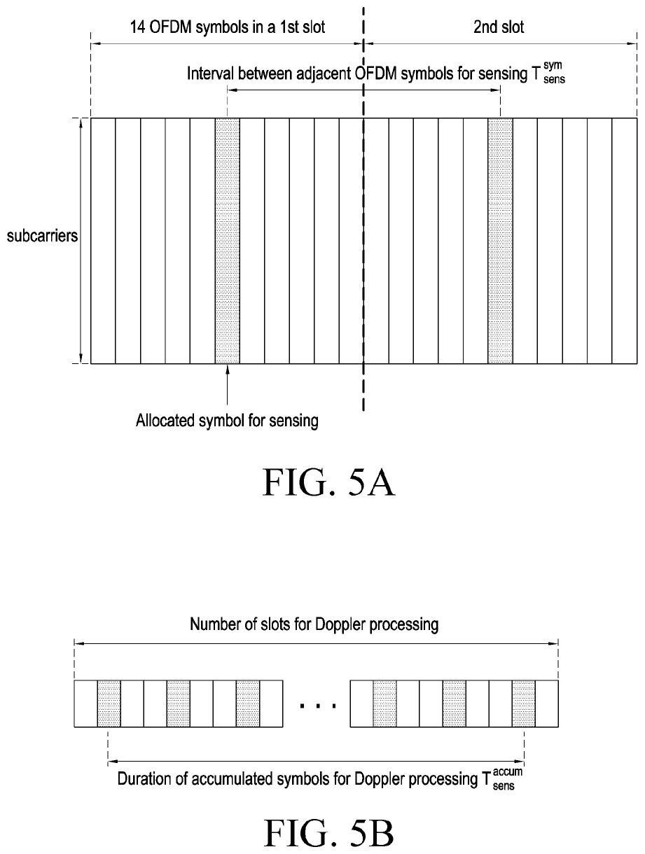

Referring to FIG. 4, in operation 1, the base station 320 may allocate resources for sensing. For example, the base station 320 may allocate time and frequency resources for sensing (or sensing signal). An example of allocating time and frequency resources for sensing may be as shown in FIGS. 5A and 5B. According to an embodiment, the sensing resource may not overlap the communication resource.

In operation 2, the base station 320 may transmit information about resource allocation for sensing (sensing resource allocation information) to the UE 310. For example, the base station 320 may transmit sensing configuration information including sensing resource allocation information to the UE 310. As an embodiment, the sensing resource allocation information may include information about time and frequency resources for sensing (or sensing signal) allocated in operation 1. Accordingly, the UE 310 may be notified of a current sensing signal allocation status for the sensing signal.

In operation 3, the base station 320 may perform a sensing operation using resources (e.g., time and frequency resources) allocated for sensing. For example, the base station 320 may transmit a sensing signal using time and frequency resources allocated for sensing. As an embodiment, the base station 320 may transmit the sensing signal through at least one beam. Further, the base station 320 may receive a sensing signal (reflection signal) reflected from a target (e.g., the UE 310 or the target 330 of FIG. 3) and obtain sensing data based on the reflection signal.

In operation 4, the UE 310 may determine an operation to be performed using the received/notified information (e.g., sensing resource allocation information, sensing configuration information, etc.). For example, the UE 310 may identify the time and frequency resources allocated for sensing based on the sensing resource allocation information, and may perform an operation (e.g., a communication operation and/or a sensing operation) based on the identified time and frequency resources.

According to an embodiment, the UE 310 may disregard time and frequency resources (or signals received through the corresponding resources) allocated for sensing.

According to an embodiment, the UE 310 may perform a communication operation using time and frequency resources other than the time and frequency resources allocated for sensing. For example, the UE 310 may receive a communication signal (DL signal) using the time and frequency resources allocated for DL communication, rather than the time and frequency resources allocated for sensing. For example, the UE 310 may transmit a communication signal (UL signal) using the time and frequency resources allocated for UL communication, rather than the time and frequency resources allocated for sensing. As an embodiment, information about time and frequency resources allocated for communication may be transferred from the base station 320 to the UE 310 through communication configuration information (e.g., PDCCH/DCI).

According to an embodiment, when the UE 310 supports a sensing function, the UE 310 may receive a sensing signal using time and frequency resources allocated for sensing and may perform a sensing operation based on the received sensing signal. The UE 310 may perform a sensing operation to obtain sensing data and/or a sensing result.

Meanwhile, according to an embodiment, some of the above-described operations 1 to 4 may be omitted, and/or additional operations may be further performed. Further, the operations may be performed in a different order from the illustrated/described order, or multiple operations may be performed simultaneously.

Meanwhile, in FIG. 4, for convenience of description, a procedure between the base station 320 and one UE 310 has been described as an example, but embodiments are not limited thereto. For example, a plurality of UEs may be connected to the base station 320, and in this case, each UE may perform the same procedure as the procedure between the base station 320 and the UE 310 with the base station 320.

### [Allocation of Sensing Resources]

FIGS. 5A and 5B illustrate examples of resource allocation for sensing according to an embodiment of the present disclosure.

In the embodiments of FIGS. 5A and 5B, for convenience of description, it is assumed that the time-frequency domain structure follows the time-frequency domain structure of FIG. 2A, and the frame, subframe, and slot structure follow the frame, subframe, and slot structure of FIG. 2B, but the embodiments are not limited thereto.

As an embodiment, in the time domain, at least one OFDM symbol may be allocated for sensing. For example, as illustrated in FIG. 5A, a first OFDM symbol (e.g., a sixth OFDM symbol (symbol index=5) in a first slot (e.g., a first slot (1st slot) of a frame) and a second OFDM symbol (e.g., a sixth OFDM symbol (symbol index=5) in a second slot (e.g., a second slot (2nd slot) of a frame) following the first slot may be allocated for sensing.

As an embodiment, in the time domain, symbols for sensing may be allocated at preset intervals. For this purpose, the interval (Tₛₑₙₛ^{sym}) between adjacent OFDM symbols for sensing may be set by the base station 320. Thus, OFDM symbols for sensing may be allocated in the time domain at the same interval.

As an embodiment, in the time domain, OFDM symbols and/or slots corresponding to a preset number (or duration) for Doppler processing may be allocated. For this purpose, the number of slots for Doppler processing and/or the duration (Tₛₑₙₛ^{accum}) of the accumulated symbols (OFDM symbols) for Doppler processing may be set by the base station 320. Thus, as shown in FIG. 5B, a preset number of OFDM symbols in the time domain may be allocated for sensing. As an embodiment, the duration (Tₛₑₙₛ^{accum}) may be associated with the number of symbols for Doppler processing.

As an embodiment, the base station 320 may set the interval (Tₛₑₙₛ^{sym}), the number of slots and/or duration (Tₛₑₙₛ^{accum}) for Doppler processing. For example, the base station 320 may allocate OFDM symbols for sensing in the time domain, based on the interval (Tₛₑₙₛ^{sym}), the number of slots and/or the duration (Tₛₑₙₛ^{accum}) for Doppler processing. The base station 320 may transmit information (sensing time resource information) about the time resource allocated for sensing to the UE 310. As an embodiment, the sensing time resource information may include at least one of the interval (Tₛₑₙₛ^{sym}), the number of slots or duration (Tₛₑₙₛ^{accum}) for Doppler processing. Thus, the UE 310 may be notified of the OFDM symbol allocation status for sensing. The UE 310 may perform an operation based on the notified information. Meanwhile, the duration (Tₛₑₙₛ^{accum}) is information that is sufficient for the receiving device (e.g., base station 320) of the sensing signal to know, and the UE 310 may not be notified of the duration.

As an embodiment, in the frequency domain, all or some of the subcarriers of the OFDM symbol allocated for sensing may be allocated for sensing. For example, as shown in FIG. 5A, all of the subcarriers associated with the OFDM symbol allocated for sensing may be allocated for sensing. For example, as shown in FIG. 4, some of the subcarriers associated with the OFDM symbol allocated for sensing may be allocated for sensing. In this case, the allocated subcarriers may be contiguous subcarriers.

### [Block Diagram of JCAS-Enabled Device]

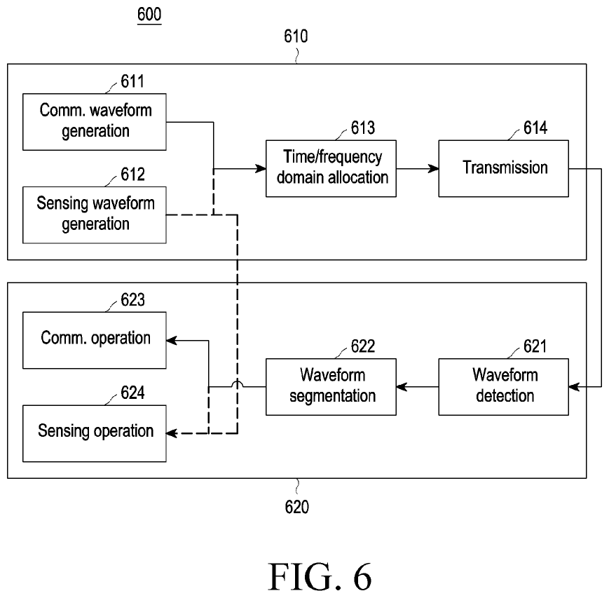

FIG. 6 illustrates an example of a JCAS-enabled device using different waveforms for sensing and communication according to an embodiment of the present disclosure.

In the embodiment of FIG. 6, the JCAS supporting device 600 may use different waveforms for sensing and communication. The JCAS supporting device 600 may be the base station 320 but is not limited thereto.

Referring to FIG. 6, the JCAS supporting device 600 may include a transmitter 610 and a receiver 620.

The transmitter 610 may include a communication waveform generation unit 611, a sensing waveform generation unit 612, a time/frequency domain allocation unit 613, and/or a transmission unit 614.

The communication waveform generation unit 611 may generate a waveform (communication waveform) for communication (communication signal). The communication waveform according to an embodiment may be an OFDM-based waveform.

The sensing waveform generation unit 612 may generate a waveform (sensing waveform) for sensing (sensing signal). The sensing waveform according to an embodiment may be a waveform based on a frequency modulated continuous wave (FMCW). The generated data of the sensing waveform may be transferred to the sensing operation unit 624 of the receiver 620 and used for the sensing operation in the sensing operation unit 624.

The time/frequency domain allocation unit 613 may allocate time/frequency resources for the communication waveform and the sensing waveform. The time domain allocation unit 613 may allocate a time/frequency resource for the communication waveform and a time/frequency resource for the sensing waveform, respectively.

The transmission unit 614 may transmit the communication waveform and the sensing waveform using the allocated time/frequency resources.

The receiver 620 may include a waveform detection unit 621, a waveform segmentation unit 622, a communication operation unit 623, and/or a sensing operation unit 624.

The waveform detection unit 621 may receive a signal and detect a communication waveform and a sensing waveform from the signal. The sensing waveform may be a waveform of a sensing signal reflected from a target.

The waveform segmentation unit 622 may segment the detected communication waveform and sensing waveform and transfer data of the communication waveform to the communication operation unit 623 and transfer data of the reception waveform to the sensing operation unit 624.

The communication operation unit 623 may perform a communication operation using data of the communication waveform.

The sensing operation unit 624 may perform a sensing operation using data of the sensing waveform. For example, the sensing operation unit 624 may obtain correlation data between the transmission sensing waveform and the reception sensing waveform using the data of the sensing waveform (transmission sensing waveform) transferred from the sensing waveform generation unit 612 of the transmitter 610 and the data of the sensing waveform (reception sensing waveform) transferred from the waveform segmentation unit 622, and may obtain sensing data for the target based on the correlation data.

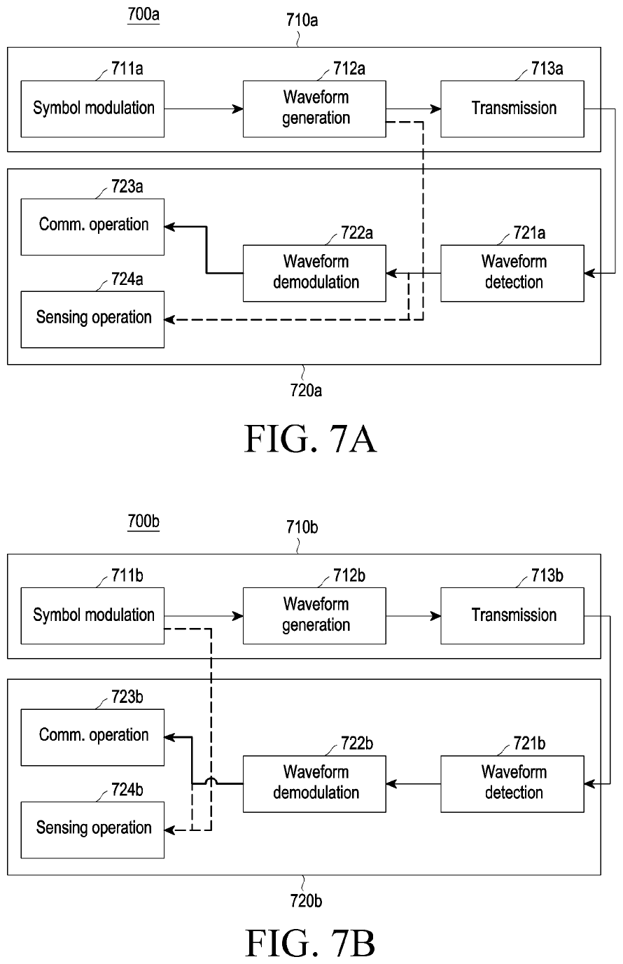

FIGS. 7A and 7B illustrate a JCAS-enabled device using the same waveform for sensing and communication according to an embodiment of the present disclosure.

Unlike in the embodiment of FIG. 6, in the embodiments of FIGS. 7A and 7B, the JCAS supporting devices 700a and 700b may use the same waveform for sensing and communication. The JCAS supporting devices 700a and 700b may be, but are not limited to, the base station 320.

In the embodiment of FIG. 7A, a baseband waveform-based correlation may be used for a sensing operation. In contrast, in the embodiment of FIG. 7B, a demodulated symbol-based correlation may be used for the sensing operation.

Referring to FIGS. 7A and 7B, the JCAS supporting devices 700a and 700b may include transmitters 710a and 710b and receivers 720a and 720b, respectively.

The transmitters 710a and 710b may include symbol modulation units 711a and 711b, waveform generation units 712a and 712b, and/or transmission units 713a and 713b. The receivers 720a and 720b may include waveform detection units 721a and 721b, waveform demodulation units 722a and 722b, communication operation units 723a and 723b, and/or sensing operation units 724a and 724b.

The symbol modulation units 711a and 711b may obtain symbol data by performing modulation on data for communication and sensing. The symbol modulation unit 711b of FIG. 7B may transmit the symbol data to the sensing operation unit 724b of the receiver 720b.

The waveform generation units 712a and 712b may generate a waveform for communication/reception using symbol data. The waveform according to an embodiment may be an OFDM-based waveform. The waveform generation unit 712a of FIG. 7A may transmit the generated waveform data to the sensing operation unit 724a of the receiver 720a.

The transmission units 713a and 713b may transmit the generated waveform.

The waveform detection units 721a and 721b may receive a signal and detect a waveform from the signal. The waveform detection unit 721a of FIG. 7A may transmit the detected waveform data to the waveform demodulation unit 722a and the sensing operation unit 724a. The waveform detection unit 721b of FIG. 7B may transmit the detected waveform data to the waveform demodulation unit 722b. The detected data of the waveform may include data of the sensing signal reflected from the target.

The waveform demodulation units 722a and 722b may demodulate the waveform data to obtain symbol data. The waveform demodulation unit 722a of FIG. 7A may transmit symbol data to the communication operation unit 723a. The waveform demodulation unit 722b of FIG. 7B may transmit symbol data to the communication operation unit 723b and the sensing operation unit 724b.

The communication operation units 723a and 723b may perform a communication operation using symbol data.

The sensing operation units 724a and 724b may perform a sensing operation.

For example, the sensing operation unit 724a of FIG. 7A may obtain (waveform-based correlation) the correlation data of the transmission waveform and the reception waveform using the waveform (reception waveform) transferred from the waveform detection unit 721a and the data of the waveform (transmission waveform) transferred from the waveform generation unit 712a and obtain sensing data for the target based on the correlation data.

For example, the sensing operation unit 724b of FIG. 7B may obtain correlation data (symbol-based correlation) using the symbol data transferred from the waveform demodulation unit 722b and the symbol data transferred from the symbol modulation unit 711b and may obtain sensing data for the target based on the correlation data.

### [Sensing Configuration Information]

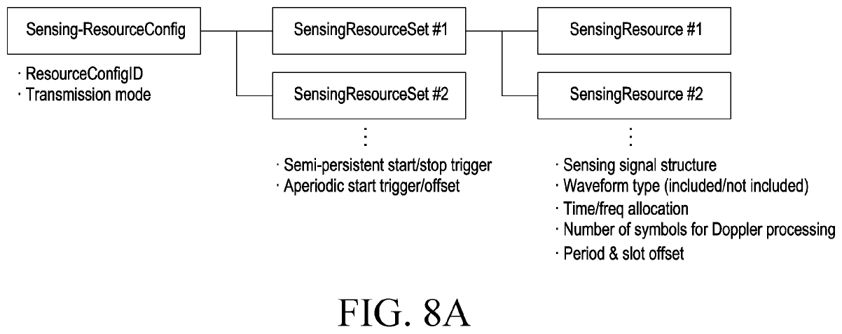

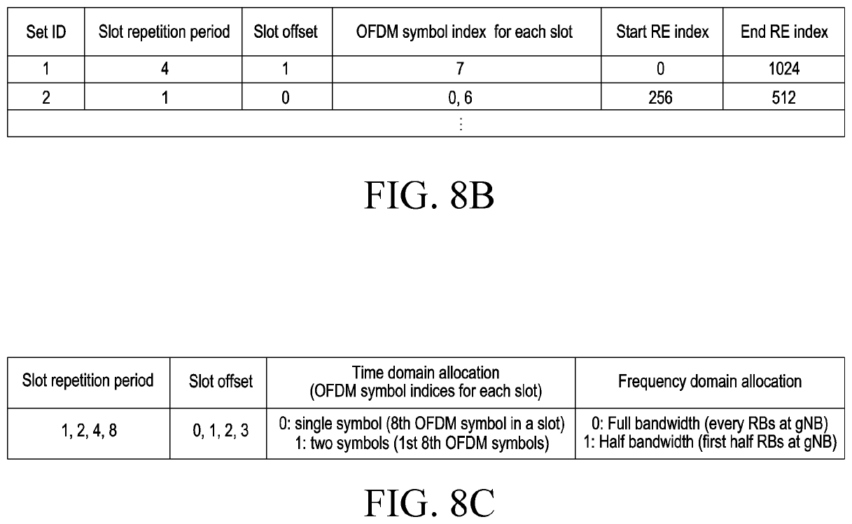

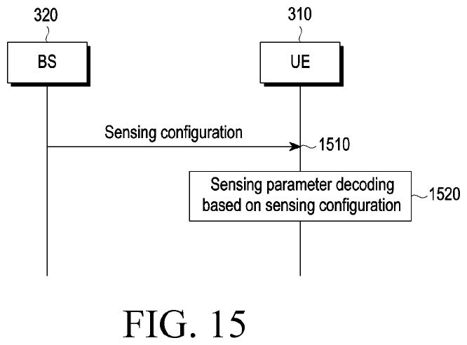

Hereinafter, a configuration of information (sensing configuration information) for configuration of sensing and a method in which the base station notifies the UE of the sensing configuration information are described. Parameters included in the sensing configuration information of FIGS. 8A to 8C and FIG. 15, which is described below, may be combined with each other, or may be changed/replaced unless contradiction occurs.

FIG. 8A illustrates an example of sensing configuration information according to an embodiment of the present disclosure.

In the embodiment of FIG. 8A, the sensing configuration information may have a hierarchical structure.

As an embodiment, the sensing configuration information of FIG. 8A may be used in a monostatic sensing structure.

Referring to FIG. 8A, the sensing configuration information may include at least one piece of sensing resource configuration information (e.g., Sensing-ResourceConfig).

The sensing resource configuration information may include resource configuration ID information (e.g., ResourceConfigID), transmission mode information (e.g., Transmission mode), and/or at least one sensing resource set information (e.g., SensingResourceSet #1, SensingResourceSet #2, etc.).

The resource configuration ID information may indicate the ID of the sensing resource configuration information.

The transmission mode information may indicate a transmission mode of a sensing signal (or a sensing sequence) in a sensing configuration to which the sensing resource configuration information is applied. As an embodiment, the transmission mode may be one of a periodic transmission mode, a semi-persistent transmission mode, and an aperiodic transmission mode.

As an embodiment, the resource configuration ID information and the transmission mode information may be information of the sensing resource configuration information-level which is a higher level of the sensing resource set information-level, and a separate resource configuration ID (or sensing resource configuration information identified by the resource configuration ID) may be allocated for each transmission mode indicated by the transmission mode information. For example, the resource configuration ID of the sensing resource configuration information for the periodic transmission mode may be different from the resource configuration ID of the sensing resource configuration information for the aperiodic transmission mode. As described above, by configuration the resource configuration ID information and the transmission mode information as the information of the highest level of the sensing resource configuration information, it is possible to configure separate sensing resource set information/sensing resource information for each transmission mode.

The sensing resource set information may include at least one piece of sensing resource information (e.g., SensingResource #1 and SensingResource #2).

The sensing resource set information may further include sensing resource set information-level information that differs according to the transmission mode. For example, when the transmission mode is the semi-persistent transmission mode, the sensing resource set information may include trigger information (semi-persistent start trigger) for starting the semi-persistent transmission mode for the corresponding sensing resource set (e.g., SensingResourceSet #1) and/or trigger information (semi-persistent stop trigger) for stopping the semi-persistent transmission mode. For example, when the transmission mode is the aperiodic transmission mode, the sensing resource set information may include trigger information (aperiodic start trigger) and/or offset information (aperiodic offset) for starting the aperiodic transmission mode for the corresponding sensing resource set (e.g., SensingResourceSet #1). The sensing resource set information level may be a higher level of the sensing resource information-level.

The sensing resource information may include information about a sensing resource according to a sensing requirement or an application requirement. As an embodiment, a plurality of sensing resource information configured for each sensing requirement (or application) may be included in one piece of sensing resource set information. For example, SensingResource #1 configured according to the first sensing requirement (or the first application) and SensingResource #2 configured according to the second sensing requirement (or the second application) may be included in one piece of sensing resource set information (e.g., SensingResourceSet #1). As an embodiment, a plurality of sensing resource set information configured for each sensing requirement (or first application) may be included in one piece of sensing resource configuration information. For example, SensingResourceSet #1 configured according to the first sensing requirement (or the first application) and SensingResourceSet #2 configured according to the second sensing requirement (or the second application) may be included in one piece of sensing resource configuration information.

The sensing resource information according to an embodiment may include information about a sensing signal structure, information about a waveform type, information for measuring a range, and/or information for Doppler processing. As an embodiment, the information for measuring the range may include frequency resource allocation information for sensing. As an embodiment, the information for Doppler processing may include time resource allocation information for sensing, information about a period for transmitting a sensing signal, information about an offset (e.g., a slot offset) for transmitting a sensing signal, and/or information about the number of symbols required for Doppler processing (symbol count information for Doppler processing). As an embodiment, when the same waveform is used for sensing and communication, information about the waveform type may not be included in the sensing resource information.

According to an embodiment, the base station 320 may transmit sensing configuration information to the UE 310 through higher layer signaling and/or PHY layer signaling.

For example, the base station 320 may transmit sensing configuration information using a radio resource control (RRC) message that is higher layer signaling. As an embodiment, the RRC message may include the whole or part of the information included in the sensing configuration information.

For example, the base station 320 may transmit sensing configuration information using system information (e.g., a system information block (SIB)) that is higher layer signaling. As an embodiment, the SIB may include part of the information included in the sensing configuration information.

For example, the base station 320 may transmit sensing configuration information using a control element (MAC CE) that is higher layer signaling. As an embodiment, the MAC CE may include the whole or part of information included in the sensing configuration information.

For example, the base station 320 may transmit sensing configuration information using DCI, which is PHY layer signaling. As an embodiment, the DCI may include the whole or part of the information included in the sensing configuration information.

FIG. 8B illustrates an example of sensing configuration information according to an embodiment of the present disclosure.

The sensing configuration information of FIG. 8B may be used for the periodic transmission mode.

Referring to FIG. 8B, the sensing configuration information may have a form of a predefined table. For example, a configuration table for a sensing parameter set, such as the table of FIG. 8B, may be predefined. In the table, the setting values of the sensing parameters included in the sensing parameter set may be set to differ for each set ID indicated by the set ID information. For example, as illustrated in FIG. 8B, the setting values of the sensing parameters included in the sensing parameter set for the first set ID (set ID=1) may be different from the setting values of the sensing parameters included in the sensing parameter set for the second set ID (set ID=2).

As an embodiment, the sensing parameter set may include at least one sensing parameter. For example, as illustrated in FIG. 8B, the sensing parameter set may include a slot repetition period parameter/information, a slot offset parameter/information, an OFDM symbol index parameter/information for each slot, a start RE index parameter/information, and/or an end RE index parameter/information.

The slot repetition period information, the slot offset, and the OFDM symbol index information for each slot may be used for time resource allocation for sensing.

The slot repetition period information may specify a period (slot repetition period) in which the OFDM symbol (sensing symbol) where a sensing sequence (or sensing data) is transmitted is allocated. As an embodiment, the slot repetition period information may indicate the period in which the sensing symbol is allocated as the number of slots. In the disclosure, the slot repetition period information may be referred to as repetition period information and period information.

The slot offset information may specify the offset from the start time of the period specified by the slot repetition period information to the start time of the slot (sensing slot) where the sensing symbol is allocated. As an embodiment, the slot offset information may specify an offset on a per-slot basis. In the disclosure, the slot offset information may be referred to as offset information.

The OFDM symbol index information for each slot may specify the index of the OFDM symbol corresponding to the sensing symbol in each slot where the sensing symbol is allocated. When a plurality of sensing symbols is allocated in the corresponding slot, the OFDM symbol index information for each slot may specify an OFDM symbol index for each of the plurality of sensing symbols. In the disclosure, OFDM symbol index information for each slot may be referred to as sensing symbol index information.

The start RE index information and the end RE index information may be used for frequency resource allocation for sensing.

The start RE index information may specify the index of the start RE for continuous frequency allocation. The end RE index information may specify the index of the end RE for continuous frequency allocation. Continuous frequency resources specified by the start RE index information and the end RE index information may be used for sensing.

As an embodiment, the setting values of the parameters included in the sensing parameter set configured for each value of the set ID in the table of Table 8B may be fixed values (e.g., values defined in the standards) or values previously shared between devices for sensing. Accordingly, devices for sensing (e.g., the base station 320 and the UE 310) may previously know setting values (e.g., table values in Table 8B) of parameters included in the sensing parameter set configured for each set ID value. Therefore, the base station 320 may transmit only a value of set ID information to be used as sensing configuration information to the UE 310 for allocating sensing resources. Accordingly, signaling overhead may be reduced. In this case, the UE 310 may obtain setting values of parameters included in the sensing parameter set corresponding to the set ID, based on the set ID of the set ID information, and may perform an operation (e.g., the communication operation and/or the sensing operation) based on the setting values.

According to an embodiment, the base station 320 may transmit set ID information (or sensing configuration information including set ID information) to the UE 310 through higher layer signaling (e.g., SIB, RRC message and/or MAC CE) or PHY layer signaling (e.g., DCI). For example, the base station 320 may transmit an SIB, an RRC message, and/or a MAC CE including set ID information to the UE 310. For example, the base station 320 may transmit DCI including set ID information to the UE 310.

FIG. 8C illustrates an example of sensing configuration information according to an embodiment of the present disclosure.

The sensing configuration information of FIG. 8C may be used for the periodic transmission mode.

Referring to FIG. 8C, the sensing configuration information may have a form of a bitmap. For example, the configuration for the sensing parameter set may be configured in the form of a bitmap.

As an embodiment, the sensing parameter set may include at least one sensing parameter. For example, as illustrated in FIG. 8C, the sensing parameter set may include a slot repetition period parameter/information, a slot offset parameter/information, a time domain allocation parameter/information, and/or a frequency domain allocation parameter/information.

The slot repetition period information, the slot offset, and the time domain allocation information may be used for time resource allocation for sensing.

The slot repetition period information may specify a period (slot repetition period) in which the OFDM symbol (sensing symbol) where a sensing sequence (or sensing data) is transmitted is allocated. As an embodiment, the slot repetition period information may indicate the period in which the sensing symbol is allocated as the number of slots. As an embodiment, the slot repetition period information may be set to the two-bit value that specifies the period (e.g., 1, 2, 4, 8) in which the sensing symbol is allocated.

The slot offset information may specify the offset from the start time of the period specified by the slot repetition period information to the start time of the slot where the sensing symbol is allocated. As an embodiment, the slot offset information may specify an offset on a per-slot basis. As an embodiment, the slot offset information may be set to a two-bit value that specifies the slot offset (e.g., 0, 1, 2, 3).

The time domain allocation information may be set to one of predefined values to specify the index of the OFDM symbol corresponding to the sensing symbol in each slot where the sensing symbol is allocated. For example, the time domain allocation information may be one-bit information set to one of a first value (e.g., 0) indicating that one OFDM symbol is allocated as the sensing symbol in the corresponding slot or a second value (e.g., 1) indicating that two OFDM symbols are allocated as the sensing symbol in the corresponding slot.

When the time domain allocation information is set to the first value (e.g., 0) indicating that one OFDM symbol is allocated as the sensing symbol, the value of the OFDM symbol index of the corresponding sensing symbol may be a preset value (e.g., the OFDM symbol index value corresponding to the eighth OFDM symbol).

When the time domain allocation information is set to the second value (e.g., 1) indicating that two OFDM symbols are allocated as the sensing symbol, the values of the OFDM symbol indexes of the corresponding two sensing symbols may be preset values (e.g., the OFDM symbol index value corresponding to the first OFDM symbol and the OFDM symbol index value corresponding to the eighth OFDM symbol).

The frequency domain allocation information may include information for continuous frequency allocation. As an embodiment, the frequency domain allocation information may be one-bit information set to one of the first value (e.g., 0) indicating the full bandwidth (e.g., all RBs (e.g., the total system bandwidth) available/configurable in the base station) or the second value (e.g., 1) indicating the half bandwidth (e.g., the first half RBs (e.g., the first half of the total system bandwidth) of all RBs available/configurable in the base station).

As an embodiment, the bitmap of the sensing parameter set may be set to a total of 6 bits. For example, as illustrated in FIG. 8C, 2 least significant bits (LSBs) among 6 bits may be used to configure slot repetition period information, the next 2 bits may be used to configure slot offset information, the next 1 bit may be used to configure time domain allocation information, and 1 most significant bit (MSB) may be used to configure frequency domain allocation information. However, this is merely an example of a bitmap of a sensing parameter set, and embodiments are not limited thereto.

For example, it is also possible to use a bitmap in which the parameters (information) of the sensing parameter set are configured in a different order from the order illustrated in FIG. 8C.

For example, some parameters (information) of the sensing parameter set may be omitted, or a bitmap further including additional parameters (information) may be used. In this case, the length of the bitmap may be longer or shorter than 6 bits.

According to an embodiment, the type and order of the parameters (information) included in the sensing parameter set configured in the form of the bitmap, and bitmap length may be fixed values (e.g., values defined in the standards), or may be values previously shared between devices for sensing. Accordingly, the base station 320 may transmit only the bitmap (sensing parameter bitmap) of the sensing parameter set to the UE 310 for allocating sensing resources. Accordingly, signaling overhead may be reduced. In this case, the UE 310 may obtain the setting values of the parameters included in the sensing parameter set corresponding to the sensing parameter bitmap, based on the setting values of the sensing parameter bitmap, and may perform an operation (e.g., a communication operation and/or a sensing operation) based thereon.

According to an embodiment, the base station 320 may transmit the sensing parameter bitmap (or sensing configuration information including the sensing parameter bitmap) to the UE 310 through higher layer signaling (e.g., SIB, RRC message and/or MAC CE) or PHY layer signaling (e.g., DCI). For example, the base station 320 may transmit an SIB, an RRC message, and/or a MAC CE including the sensing parameter bitmap to the UE 310. For example, the base station 320 may transmit the DCI including the sensing parameter bitmap to the UE 310.

Meanwhile, the sensing parameters in the sensing parameter set of FIG. 8B and the sensing parameters in the sensing parameter set of FIG. 8C may be combined or replaced with each other.

For example, some or all of the parameters in the sensing parameter set of FIG. 8C may be used to configure the configuration table of FIG. 8B, together with, or instead of, some or all of the parameters in the sensing parameter set of FIG. 8B. For example, some or all of the parameters in the sensing parameter set of FIG. 8B may be used to configure the sensing parameter bitmap of FIG. 8C, together with, or instead of, some or all of the parameters in the sensing parameter set of FIG. 8C.

For example, the sensing symbol index information (OFDM symbol index for each slot) of FIG. 8B may be replaced with the time domain allocation information of FIG. 8C and used, or vice versa. For example, the start RE index information and the end RE index information of FIG. 8B may be replaced with the frequency domain allocation information of FIG. 8C and used, or vice versa.

### [Sensing Resource Allocation for Periodic Transmission]

Hereinafter, an example of sensing resource allocation configured based on sensing configuration information is described. Sensing resource allocation may be performed by the base station 320.

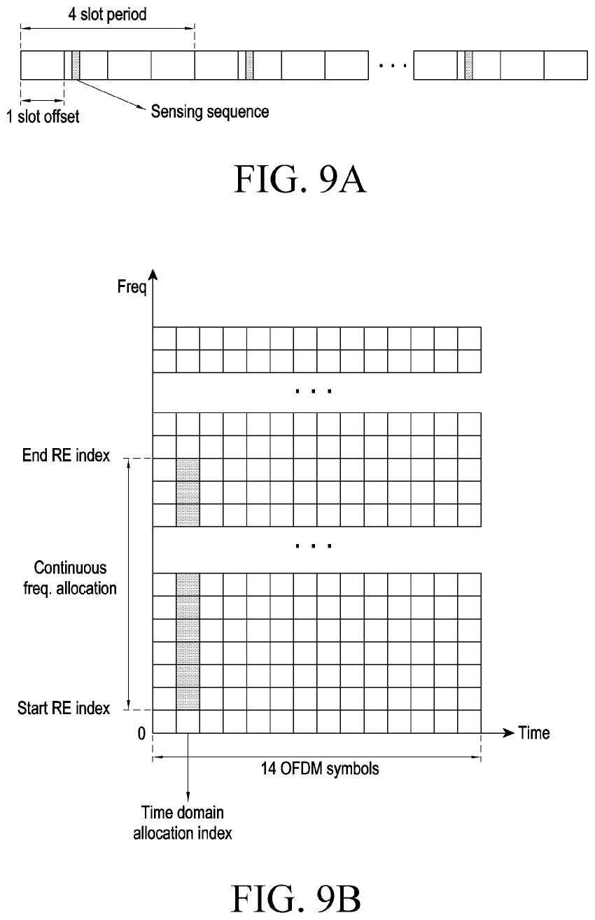

In the embodiments of FIGS. 9A and 9B, for convenience of description, it is assumed that the time-frequency domain structure follows the time-frequency domain structure of FIG. 2A, and the frame, subframe, and slot structure follow the frame, subframe, and slot structure of FIG. 2B, but the embodiments are not limited thereto.

FIG. 9A illustrates an example of sensing resource allocation according to an embodiment of the present disclosure.

In the time domain, the time resource for sensing may be allocated in a slot-level. In this case, slot repetition period information, slot offset information, and/or time resource allocation information may be used as sensing configuration information to configure a time resource for sensing. As an embodiment, the time resource allocation information may be sensing symbol index information of FIG. 8B or time domain allocation information of FIG. 8C.

The embodiment of FIG. 9 may be an embodiment in which the value of slot repetition period information is set to a value indicating that the slot repetition period is 4, the value of slot offset information is set to a value indicating that the slot offset is 1, and the value of time resource allocation information is set to a value indicating the index of the second OFDM symbol in the slot where the sensing symbol including the sensing sequence (data) is allocated. In this case, as illustrated, the allocation of the sensing symbol (or the sensing resource) may be repeated in a period corresponding to the length of the four slots, the slot (the second slot of the corresponding period) one slot offset away from the start slot of the corresponding period may be allocated as the slot where the sensing symbol is allocated, and the second OFDM symbol in the corresponding slot may be allocated as the sensing symbol. Meanwhile, unlike shown, a plurality of OFDM symbols in one slot may be allocated as sensing symbols.

FIG. 9B illustrates an example of sensing resource allocation according to an embodiment of the present disclosure.

In the time domain, the time resource for sensing may be allocated in an OFDM symbol-level. Further, in the frequency domain, the time resource for sensing may be allocated in an RE-level.

In the case of OFDM symbol-level allocation, time resources may be allocated on a per-OFDM symbol basis in the slot. In this case, time resource allocation information may be used as sensing configuration information to configure a time resource for sensing. As an embodiment, the time resource allocation information may be sensing symbol index information of FIG. 8B or time domain allocation information of FIG. 8C.

In the case of RE-level allocation, for continuous frequency resource allocation (continuous frequency allocation) on a per-RE basis, the start RE index information and the end RE index information of FIG. 8B may be used as sensing configuration information.

The embodiment of FIG. 9B may be an embodiment in which the value of time resource allocation information is set to a value indicating the index of the second OFDM symbol in the slot where the sensing symbol is allocated, start RE index information is set to a value indicating the index of the RE corresponding to the second subcarrier of the corresponding OFDM symbol, and end RE index information is set to a value indicating the index of the nth RE of the corresponding OFDM symbol. In this case, as illustrated, the RE (start RE) corresponding to start RE index information of the second OFDM symbol in the corresponding slot to the RE (end RE) corresponding to end RE index information may be allocated as the frequency resource (area) for sensing in the continuous RE. Meanwhile, unlike shown, a plurality of OFDM symbols in one slot may be allocated as sensing symbols. Further, according to an embodiment, it is also possible to allocate continuous frequencies for sensing in the RB-level rather than the RE-level. In this case, information indicating the index of the start RB (start RB index information) and information indicating the index of the end RB (end RB index information) may be used as sensing configuration information.

### [Operation According to Transmission Mode]

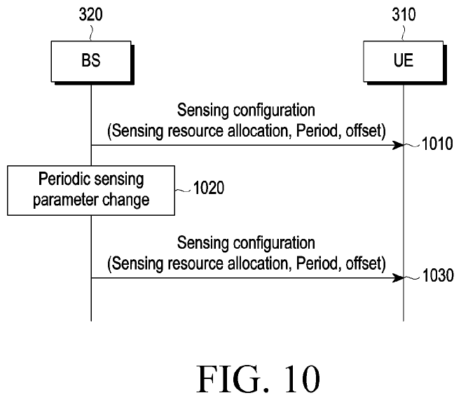

FIG. 10 illustrates an example of a sensing procedure according to a periodic transmission mode according to an embodiment of the present disclosure.

In the periodic transmission mode, the base station 320 may transmit sensing configuration information including minimum configuration information for periodic transmission to the at least one UE 310. For example, the base station 320 may transmit information related to time/frequency allocation for periodic transmission, information related to the period (e.g., slot repetition period information), and information related to the offset (e.g., slot offset information) to the at least one UE 310 as sensing configuration information.

In the periodic transmission mode, the base station 320 may repeatedly transmit the sensing signal based on the set period/offset and time/frequency allocation.

In the periodic transmission mode, when it is necessary to change the sensing configuration for periodic transmission, the base station 320 may transmit the changed sensing configuration information to at least one UE 310 and may perform a sensing operation using the changed sensing configuration.

Hereinafter, an exemplary sensing procedure according to a periodic transmission mode is described with reference to FIG. 10.

Referring to FIG. 10, in operation 1010, the base station 320 may transmit sensing configuration information for configuring sensing according to the periodic transmission mode to the UE 310. The base station 320 and the UE 310 may perform a communication operation and/or a sensing operation based on the sensing configuration information.

In operation 1020, the base station 320 may identify a change in sensing configuration information (or some or all of sensing parameters (information) included in the sensing configuration information) for the periodic transmission mode.

In operation 1030, the base station 320 may transmit the changed sensing configuration information to the UE 310. The base station 320 and the UE 310 may perform a communication operation and a sensing operation based on the changed sensing configuration information.

According to an embodiment, the base station 320 may transmit sensing configuration information (or changed sensing configuration information) to the UE 310 through higher layer signaling (e.g., SIB, RRC message and/or MAC CE) and/or PHY layer signaling (e.g., DCI). For example, the base station 320 may transmit an RRC message including sensing configuration information (or changed sensing configuration information) to the UE 320. For example, the base station 320 may transmit an RRC message including sensing configuration information (or changed sensing configuration information) to the UE 320. For example, the base station 320 may broadcast an SIB including sensing configuration information (or changed sensing configuration information). For example, the base station 320 may transmit a DCI including sensing configuration information (or changed sensing configuration information) to the UE 320.

According to an embodiment, the sensing configuration information may include sensing resource allocation information (e.g., time resource allocation information and/or frequency resource allocation information), period information (e.g., slot repetition period information), and/or offset information (e.g., slot offset information).

According to an embodiment, the sensing configuration information may include the whole or part of information included in at least one piece of sensing resource configuration information (e.g., the sensing resource configuration information of FIG. 8A).

The sensing configuration information according to an embodiment may include set ID information (e.g., set ID information of FIG. 8B).

The sensing configuration information according to an embodiment may include a sensing parameter bitmap (e.g., the sensing parameter bitmap of FIG. 8C).

According to an embodiment, an example of sensing resource allocation according to the periodic transmission mode may be as shown in FIG. 9A and/or FIG. 9B.

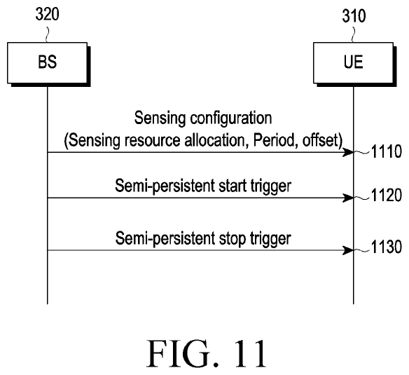

FIG. 11 illustrates an example of a sensing procedure according to a semi-persistent transmission mode according to an embodiment of the present disclosure.

In the semi-persistent transmission mode, the base station 320 may transmit sensing configuration information for the semi-persistent transmission to the at least one UE 310. For example, the base station 320 may transmit information related to time/frequency allocation for semi-persistent transmission, information related to the period (e.g., slot repetition period information), and information related to the offset (e.g., slot offset information) to the UE 310 as sensing configuration information.

In the semi-persistent transmission mode, the base station 320 may start transmission of the sensing signal from the time when the semi-persistent start trigger is transmitted to the at least one UE 310.

In the semi-persistent transmission mode, the base station 320 may repeatedly transmit a sensing signal in a set period before transmitting a semi-persistent stop trigger to the at least one UE 310.

Hereinafter, an exemplary sensing procedure according to a semi-persistent transmission mode is described with reference to FIG. 11.

Referring to FIG. 11, in operation 1110, the base station 320 may transmit sensing configuration information for configuring sensing according to the semi-persistent transmission mode to the UE 310. The base station 320 and the UE 310 may perform a communication operation and/or a sensing operation based on the sensing configuration information.

In operation 1120, to start the semi-persistent transmission, the base station 320 may transmit a semi-persistent start trigger to the UE 310. The base station 320 may start transmission of a sensing signal (or a sensing sequence) from the time when the semi-persistent start trigger is transmitted. As an embodiment, the semi-persistent start trigger may be transmitted together with sensing configuration information. In this case, operations 1110 and 1120 may be performed as one operation.

In operation 1130, to stop the semi-persistent transmission, the base station 320 may transmit a semi-persistent stop trigger to the UE 310. The base station 320 may stop transmission of the sensing signal after the semi-persistent stop trigger is transmitted. As such, in the semi-persistent transmission mode, the base station 320 may repeatedly (or periodically) transmit the sensing signal from the time when the semi-persistent start trigger is transmitted to the time when the semi-persistent stop trigger is transmitted. As such, the semi-persistent transmission mode differs from the periodic transmission mode in that the transmission start time and end time are based on transmission of the corresponding triggers of the base station 320, but the periodic transmission operation of the sensing signal between the start time and the end time may be the same as the periodic transmission operation of the periodic transmission mode.

According to an embodiment, the base station 320 may transmit sensing configuration information for the semi-persistent transmission mode to the UE 310 through higher layer signaling (e.g., SIB, RRC message and/or MAC CE) or PHY layer signaling (e.g., DCI). For example, the base station 320 may transmit an RRC message including sensing configuration information for the semi-persistent transmission mode to the UE 320. For example, the base station 320 may transmit the MAC CE including sensing configuration information for the semi-persistent transmission mode to the UE 320. For example, the base station 320 may broadcast an SIB including sensing configuration information for the semi-persistent transmission mode. For example, the base station 320 may transmit a DCI including sensing configuration information for the semi-persistent transmission mode to the UE 320.

According to an embodiment, the sensing configuration information may include sensing resource allocation information (e.g., time resource allocation information and/or frequency resource allocation information), period information (e.g., slot repetition period information), and/or offset information (e.g., slot offset information).

According to an embodiment, the sensing configuration information may include the whole or part of information included in at least one piece of sensing resource configuration information (e.g., the sensing resource configuration information of FIG. 8A).

The sensing configuration information according to an embodiment may include set ID information (e.g., set ID information of FIG. 8B).

The sensing configuration information according to an embodiment may include a sensing parameter bitmap (e.g., the sensing parameter bitmap of FIG. 8C).

According to an embodiment, the base station 320 may transmit a semi-persistent start trigger to the UE 310 through higher layer signaling (e.g., RRC message and/or MAC CE) or PHY layer signaling (e.g., DCI). For example, the base station 310 may transmit an RRC message including a semi-persistent start trigger. For example, the base station 310 may transmit a MAC CE including a semi-persistent start trigger to the UE 320. For example, the base station 310 may transmit a DCI including a semi-persistent start trigger to the UE 320.

According to an embodiment, the base station 320 may transmit a semi-persistent stop trigger to the UE 310 through higher layer signaling (e.g., RRC message and/or MAC CE) or PHY layer signaling (e.g., DCI). For example, the base station 310 may transmit an RRC message including a semi-persistent stop trigger. For example, the base station 310 may transmit a MAC CE including a semi-persistent stop trigger to the UE 320. For example, the base station 310 may transmit a DCI including a semi-persistent stop trigger to the UE 320.

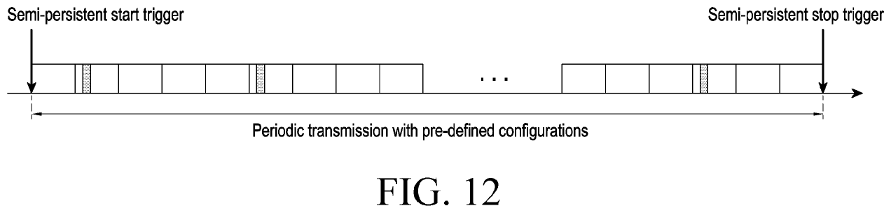

An example of sensing resource allocation according to a semi-persistent transmission mode according to an embodiment may be as shown in FIG. 12, which is described below.

FIG. 12 illustrates an example of sensing resource allocation according to a semi-persistent transmission mode according to an embodiment of the present disclosure.

Referring to FIG. 12, a sensing signal (or a sensing sequence) may be repeatedly (or periodically) transmitted using a sensing resource configured by sensing configuration information from the time when a semi-persistent start trigger is transmitted by the base station 320 to the time when a semi-persistent stop trigger is transmitted by the base station 320.

Like the embodiment of FIG. 9A, the embodiment of FIG. 12 may be an embodiment in which the value of slot repetition period information is set to a value indicating that the slot repetition period is 4, the value of slot offset information is set to a value indicating that the slot offset is 1, and the value of time resource allocation information is set to a value indicating the index of the second OFDM symbol in the slot where the sensing symbol including the sensing sequence (data) is allocated. In this case, as illustrated, the allocation of the sensing symbol (or the sensing resource) for sensing may be repeated in a period corresponding to the length of the four slots, the slot (the second slot of the corresponding period) one slot offset away from the start slot of the slot repetition period may be allocated as the slot where the sensing symbol is allocated, and the second OFDM symbol in the corresponding slot may be allocated as the sensing symbol. Meanwhile, unlike shown, a plurality of OFDM symbols in one slot may be allocated as sensing symbols.

According to an embodiment, in the semi-persistent transmission mode, the start time of the first period (slot repetition period) may correspond to the time when the semi-persistent start trigger is transmitted by the base station 320.

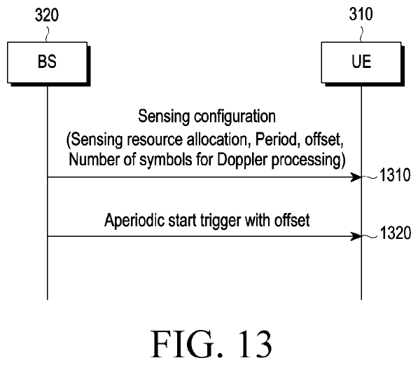

FIG. 13 illustrates an example of a sensing procedure according to an aperiodic transmission mode according to an embodiment of the present disclosure.

In the aperiodic transmission mode, the base station 320 may transmit sensing configuration information for aperiodic transmission to the at least one UE 310. For example, the base station 320 may transmit information related to time/frequency allocation for aperiodic transmission, information related to the period (e.g., slot repetition period information), information related to the offset (e.g., slot offset information), and/or information related to the number of symbols for Doppler processing (e.g., the number of symbols for Doppler processing in FIG. 8A) to the at least one UE 310 as sensing configuration information.

In the aperiodic transmission mode, the base station 320 may transmit an aperiodic start trigger to the at least one UE 310 together with the offset information.

In the aperiodic transmission mode, the base station 320 may start transmission of the sensing signal from the time away from the time when the aperiodic start trigger is transmitted by the offset (aperiodic offset) indicated by the offset information.

In the aperiodic transmission mode, the UE 310 may obtain (or calculate) the expected transmission duration based on the information related to the period, the information related to the offset, and the information related to the number of symbols for Doppler processing.

In the aperiodic transmission mode, the base station 320 may periodically (or repeatedly) transmit the sensing signal in the period set by the information related to the period during the transmission duration. As an embodiment, the transmission duration may be obtained based on information related to the period and information related to the number of symbols for Doppler processing. For example, the transmission duration may be calculated based on the product of the period indicated by the information related to the period and the number of symbols indicated by the information related to the number of symbols for Doppler processing.

In the aperiodic transmission mode, when the transmission duration expires, the aperiodic transmission may be terminated. In other words, in the aperiodic transmission mode, the transmission may be terminated when the transmission duration expires without transmission of a separate stop/end trigger.

Hereinafter, an exemplary sensing procedure according to an aperiodic transmission mode is described with reference to FIG. 13.

Referring to FIG. 13, in operation 1310, the base station 320 may transmit sensing configuration information for configuring sensing according to the aperiodic transmission mode to the UE 310. The base station 320 and the UE 310 may perform a communication operation and/or a sensing operation based on the sensing configuration information.

In operation 1320, to start the aperiodic transmission, the base station 320 may transmit the aperiodic start trigger to the UE 310 together with the aperiodic offset information. The base station 320 may start transmission of the sensing signal (or sensing sequence) from the time away from the time when the aperiodic start trigger is transmitted by the aperiodic offset indicated by the offset information. As an embodiment, the aperiodic offset information may specify the aperiodic offset on a per-slot basis.

The base station 320 may periodically (or repeatedly) transmit the sensing signal during the transmission duration according to the sensing configuration configured by the sensing configuration information. When the transmission duration expires, the aperiodic transmission may be terminated. As an embodiment, the aperiodic start trigger/aperiodic offset information may be transmitted together with sensing configuration information. In this case, operations 1310 and 1320 may be performed as one operation.

According to an embodiment, the base station 320 may transmit sensing configuration information for the aperiodic transmission mode to the UE 310 through higher layer signaling (e.g., SIB, RRC message and/or MAC CE) or PHY layer signaling (e.g., DCI). For example, the base station 320 may transmit an RRC message including sensing configuration information for the aperiodic transmission mode to the UE 320. For example, the base station 320 may transmit the MAC CE including sensing configuration information for the aperiodic transmission mode to the UE 320. For example, the base station 320 may broadcast an SIB including sensing configuration information for the aperiodic transmission mode. For example, the base station 320 may transmit an DCI including sensing configuration information for the aperiodic transmission mode to the UE 320.

According to an embodiment, the sensing configuration information may include sensing resource allocation information (e.g., time resource allocation information and/or frequency resource allocation information), period information (e.g., slot repetition period information), offset information (e.g., slot offset information), and/or symbol count information for Doppler processing.

According to an embodiment, the sensing configuration information may include the whole or part of information included in at least one piece of sensing resource configuration information (e.g., the sensing resource configuration information of FIG. 8A).

The sensing configuration information according to an embodiment may include set ID information (e.g., set ID information of FIG. 8B).

The sensing configuration information according to an embodiment may include a sensing parameter bitmap (e.g., the sensing parameter bitmap of FIG. 8C).

According to an embodiment, the base station 320 may transmit the aperiodic start trigger and the aperiodic offset information to the UE 310 through higher layer signaling (e.g., RRC message and/or MAC CE) or PHY layer signaling (e.g., DCI). For example, the base station 310 may transmit an RRC message including an aperiodic start trigger and aperiodic offset information. For example, the base station 310 may transmit the MAC CE including the aperiodic start trigger and the aperiodic offset information to the UE 320. For example, the base station 310 may transmit a DCI including aperiodic start trigger and aperiodic offset information to the UE 320.

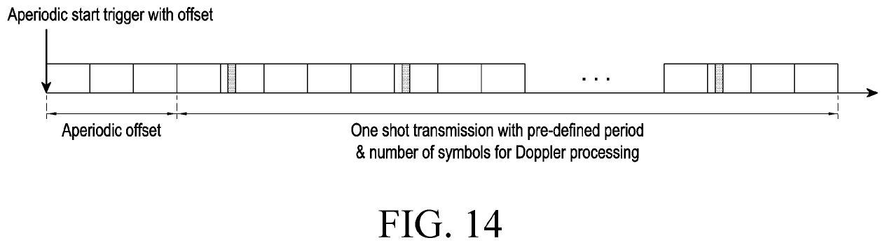

FIG. 14 illustrates an example of sensing resource allocation according to an aperiodic transmission mode according to an embodiment of the present disclosure.

Referring to FIG. 14, the sensing signal (or sensing sequence) may be repeatedly (or periodically) transmitted during the transmission duration using the sensing resource configured by the sensing configuration information from the time away from the time when the aperiodic start trigger is transmitted, by the aperiodic offset (e.g., three slot offsets) indicated by the aperiodic offset information.

Like the embodiment of FIG. 9A, the embodiment of FIG. 14 may be an embodiment in which the value of slot repetition period information is set to a value indicating that the slot repetition period is 4, the value of slot offset information is set to a value indicating that the slot offset is 1, and the value of time resource allocation information is set to a value indicating the index of the second OFDM symbol in the slot where the sensing symbol including the sensing sequence (data) is allocated. In this case, as illustrated, the allocation of the sensing symbol (or the sensing resource) for sensing may be repeated in a period corresponding to the length of the four slots, the slot (the second slot of the corresponding period) one slot offset away from the start slot of the slot repetition period may be allocated as the slot where the sensing symbol is allocated, and the second OFDM symbol in the corresponding slot may be allocated as the sensing symbol. Meanwhile, unlike shown, a plurality of OFDM symbols in one slot may be allocated as sensing symbols.

Meanwhile, in the periodic transmission mode, repeated transmission of the sensing sequence may be continuously performed until sensing configuration information for the periodic transmission mode is changed. Further, in the semi-persistent transmission mode, repeated transmission of the sensing sequence may be continuously performed until the semi-persistent stop trigger is transmitted. In contrast, in the aperiodic transmission mode, as illustrated in FIG. 14, repeated transmission of the sensing sequence is performed only once within the transmission duration set based on the sensing configuration information (one shot transmission). In other words, even if there is no separate transmission of the changed sensing configuration information and no separate transmission of the stop trigger, when the preset transmission duration expires, the aperiodic transmission is terminated.

As an embodiment, the transmission duration may be obtained based on slot repetition period information and symbol count information for Doppler processing.

For example, as illustrated in FIG. 14, when only one OFDM symbol is allocated for sensing within one period (slot repetition period) (single sensing symbol allocation), the transmission duration may correspond to the product of the period indicated by the slot repetition period information (slot repetition period) and the number of symbols indicated by the symbol count information for Doppler processing.

For example, when n OFDM symbols are allocated for sensing within one slot repetition period (multiple sensing symbols are allocated), the transmission duration may correspond to a value obtained by dividing the product of the period indicated by the slot repetition period information (slot repetition period) and the number of symbols indicated by the symbol count information for Doppler processing by n.

### [Sensing Configuration Procedure]

FIG. 15 illustrates an example of a sensing configuration procedure according to an embodiment of the present disclosure.

Referring to FIG. 15, in operation 1510, the base station 320 may transmit sensing configuration information for sensing configuration to the UE 310.

In operation 1520, the UE 310 may obtain (or decode) sensing parameter(s) based on sensing configuration information. Thereafter, the base station 320 and the UE 310 may perform a communication operation and/or a sensing operation based on the sensing configuration information.

According to an embodiment, the base station 320 may transmit sensing configuration information to the UE 310 through higher layer signaling (e.g., SIB, RRC message, MAC CE, etc.) or PHY layer signaling (e.g., DCI, etc.). For example, the base station 320 may transmit an RRC message including sensing configuration information to the UE 310. For example, the base station 320 may transmit the MAC CE including the sensing configuration information to the UE 320. For example, the base station 320 may broadcast an SIB including sensing configuration information. For example, the base station 320 may transmit a DCI including sensing configuration information to the UE 320.

The sensing configuration information according to an embodiment may include resource allocation information (sensing resource allocation information), transmission mode information, and/or transmission parameter information. Further, the sensing configuration information may optionally further include sensing sequence information (sensing sequence configuration information), quasi co-location (QCL) notification information, and/or beam information.

The resource allocation information (sensing resource allocation information) may include frequency resource allocation information and/or time resource allocation information.

As an embodiment, the frequency resource allocation information may include information about continuous frequencies allocated for sensing. For example, the frequency resource allocation information may include start RE index information and end RE index information of FIG. 8B, or frequency domain allocation information of FIG. 8C.

As an embodiment, the time resource allocation information may include OFDM symbol index information specifying the index of at least one OFDM symbol allocated for sensing. For example, the time resource allocation information may include sensing symbol index information of FIG. 8B or time domain allocation information of FIG. 8C.

The transmission mode information may indicate the transmission mode of the sensing signal. As an embodiment, the transmission mode may be one of a periodic transmission mode, a semi-persistent transmission mode, and an aperiodic transmission mode.

The transmission parameter information may include at least one piece of parameter information for transmission of the sensing signal. For example, the transmission parameter information may include period information (e.g., slot repetition period information of FIG. 8B/C), slot offset information (e.g., slot offset information of FIG. 8B/C), and/or symbol count information for Doppler processing (e.g., symbol count information for Doppler processing of FIG. 8A).

The sensing sequence information may specify the sensing sequence used for sensing. The sensing sequence information is optional information and may not be transmitted from the base station 320 to the UE 310. The UE 310 may perform a communication operation even if the sensing sequence is not known.

Meanwhile, according to an embodiment, the sensing sequence may be used for channel estimation in the UE 310. In this case, the base station 320 may transmit sensing sequence information, QCL notification information (QCL information), and/or beam information to the UE 310. The QCL notification information may include a value indicating whether an antenna port (a first antenna port) associated with a sensing signal including a sensing sequence and an antenna port (a second antenna port) associated with a PDSCH are QCLed. The beam information may include the value indicating the index of the beam where the corresponding sensing signal is transmitted. The UE 310 may identify that the first antenna port and the second antenna port (or the sensing signal and the PDSCH) are QCLed with each other using the QCL notification information and may identify that the beam through which the sensing signal is transmitted and the beam through which the PDSCH is transmitted are the same. In this case, the UE 310 may perform channel estimation using the sensing sequence specified by the sensing sequence information.

According to an embodiment, the sensing configuration information may include the whole or part of information included in at least one piece of sensing resource configuration information (e.g., the sensing resource configuration information of FIG. 8A).

The sensing configuration information according to an embodiment may include set ID information (e.g., set ID information of FIG. 8B).

The sensing configuration information according to an embodiment may include a sensing parameter bitmap (e.g., the sensing parameter bitmap of FIG. 8C).

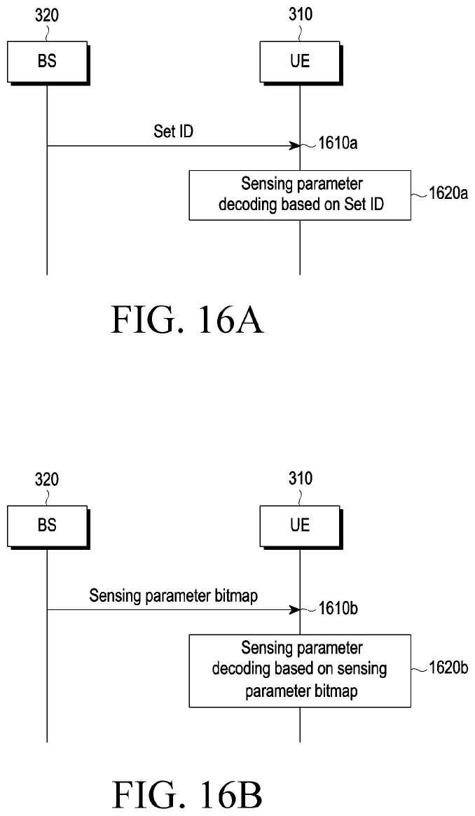

FIG. 16A illustrates an example of a sensing configuration procedure using system information (SI) according to an embodiment of the present disclosure.

The embodiment of FIG. 16A corresponds to an embodiment in which set ID information (e.g., set ID information of FIG. 8B) is broadcast using SI as sensing configuration information.

Referring to FIG. 16A, in operation 1610a, the base station 320 may broadcast the set ID information using SI. For example, the base station 320 may broadcast an SIB including set ID information. As an embodiment, the base station 320 may periodically broadcast set ID information.

When the set ID information is used as sensing configuration information, the base station 320 and the UE 310 need to already know the configuration of the sensing parameter set for each set ID.

In operation 1620a, the UE 310 may receive the set ID information and may obtain (or decode) the sensing parameter (sensing parameter set) based on the set ID information. For example, the UE 310 may obtain the configuration of the sensing parameter set corresponding to the set ID indicated by the received set ID information. For example, when the table of FIG. 8B is previously shared between the base station 320 and the UE 310, and if the set ID indicated by the received set ID information has a value of 1, a slot repetition period having a value of 4, a slot offset having a value of 1, an OFDM symbol index for each slot having a value of 7, a start RE index having a value of 0, and an end RE index having a value of 1024 may be obtained as configurations of the sensing parameter set.

Thereafter, the base station 320 and the UE 310 may perform a communication operation and/or a sensing operation based on the configuration of the sensing parameter set.

As such, when the set ID information is used as sensing configuration information, the signaling overhead may be reduced.

FIG. 16B illustrates an example of a sensing configuration procedure using system information (SI) according to an embodiment of the present disclosure.

The embodiment of FIG. 16B corresponds to an embodiment in which a sensing parameter bitmap (e.g., the sensing parameter bitmap of FIG. 8C) is broadcast using SI as sensing configuration information.

Referring to FIG. 16B, in operation 1610b, the base station 320 may broadcast the sensing parameter bitmap using the SI. For example, the base station 320 may broadcast an SIB including a sensing parameter bitmap. As an embodiment, the base station 320 may periodically broadcast the sensing parameter bitmap.

When the sensing parameter bitmap is used as sensing configuration information, the base station 320 and the UE 310 need to already know the configuration of the sensing parameter set associated with the sensing parameter bitmap. For example, the base station 320 and the UE 310 may already know the configuration of the sensing parameter bitmap.

In operation 1620a, the UE 310 may receive the sensing parameter bitmap and may obtain (or decode) the sensing parameter (the sensing parameter set) based on the sensing parameter bitmap. For example, the UE 310 may obtain the configuration of the sensing parameter set corresponding to the setting value of the sensing parameter bitmap. For example, when the sensing parameter bitmap has the configuration of the sensing parameter bitmap of FIG. 8C, the two LSBs of the total six bits of the sensing parameter bitmap may indicate the setting value of the slot repetition period information (e.g., the setting value indicating one of the slot repetition periods {1, 2, 4, 8}), the next two bits may indicate the setting value of the slot offset information (e.g., the setting value indicating one of the slot offsets {0, 1, 2, 3}), the next one bit may indicate one of the setting values of the time domain allocation information (e.g., the setting value indicating one of the time domain allocation {0 or 1}), and one MSB may indicate the setting value (e.g., the setting value indicating one of frequency domain allocation {0 or 1}) of the frequency domain allocation information.

Thereafter, the base station 320 and the UE 310 may perform a communication operation and/or a sensing operation based on the configuration of the sensing parameter set.

As such, when the sensing parameter bitmap is used as the sensing configuration information, the signaling overhead may be reduced.

### [Communication Operation of UE in JCAS System]

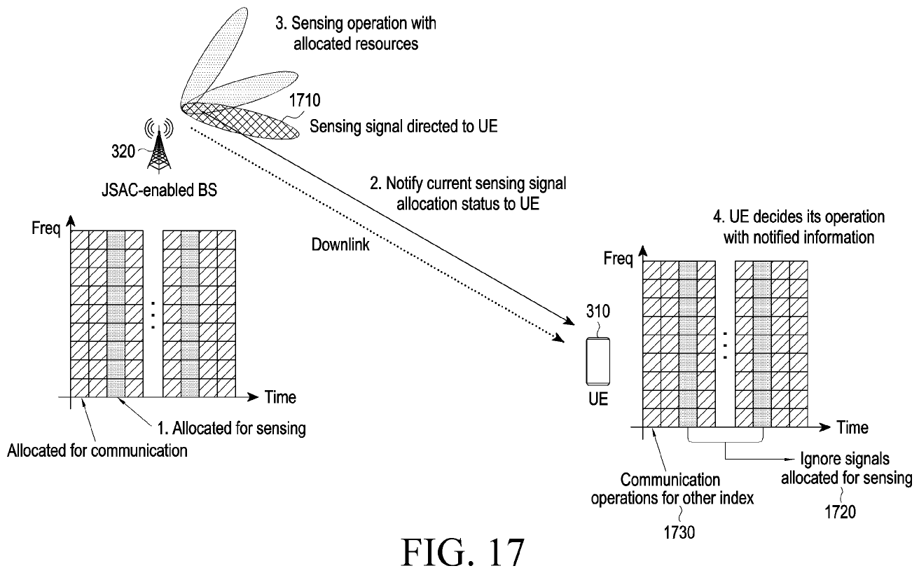

FIG. 17 illustrates an example of a downlink (DL) communication operation of a UE in a JCAS system according to an embodiment of the present disclosure.

In the case of the JCAS system, in order to perform sensing together with communication, the base station 320 needs to allocate a resource for sensing and a resource for communication and provide a notification of the allocated resource to the UE 310. In this case, unlike in a general communication system (e.g., the communication system 10 of FIG. 1), the UE 310 needs to perform an operation different from the existing communication operation in a resource area (or section) for notified sensing.

Hereinafter, a DL communication operation of a UE in a JCAS system is exemplarily described with reference to FIG. 17.

Referring to FIG. 17, in operation 1, the base station 320 may allocate resources for sensing. For example, the base station 320 may allocate time and frequency resources for sensing (or sensing signal). Further, the base station 320 may allocate resources for communication. For example, the base station 320 may allocate time and frequency resources for communication (or communication signals). As illustrated in FIG. 17, resources allocated for sensing and resources allocated for communication may not overlap.

In operation 2, the base station 320 may transmit sensing configuration information including information about resource allocation for sensing (sensing resource allocation information) to the UE 310. As an embodiment, the sensing resource allocation information may include information about time and frequency resources for sensing (or sensing signal) allocated in operation 1. Accordingly, the UE 310 may be notified of a current sensing signal allocation status for the sensing signal.

According to an embodiment, the base station 320 may transmit, to the UE 310, communication configuration information including information about resource allocation for DL communication (DL communication resource allocation information), together with sensing configuration information or separately. In an embodiment, the communication resource allocation information may include information about time and frequency resources for the communication (or communication signal) allocated in operation 1. Accordingly, the UE 310 may be notified of the current resource allocation status for the communication signal.

In operation 3, the base station 320 may perform a sensing operation using resources (e.g., time and frequency resources) allocated for sensing. For example, the base station 320 may transmit a sensing signal using time and frequency resources allocated for sensing. As an embodiment, the base station 320 may transmit the sensing signal through at least one beam. For example, the base station 320 may transmit a sensing signal directed to the UE 310 through the beam 1710 directed toward the UE 310. The base station 320 may receive a reflection (reflection signal) of the sensing signal reflected from the target (e.g., the UE 310 or the target 330 of FIG. 3) and may obtain sensing data and/or a sensing result based on the reflection signal.

According to an embodiment, the base station 320 may perform a communication operation using resources (e.g., time and frequency resources) allocated for communication. For example, the base station 320 may transmit a communication signal (DL communication signal) through the PDSCH using the time and frequency resources allocated for communication. As an embodiment, the base station 320 may transmit a DL communication signal through at least one beam.

In operation 4, the UE 310 may determine an operation to be performed using the received/notified information (e.g., sensing resource allocation information and sensing configuration information). For example, the UE 310 may identify the time and frequency resources allocated for sensing based on the sensing resource allocation information and may perform an operation based on the identified time and frequency resources.

According to an embodiment, the UE 310 may disregard signals received through time and frequency resources allocated for sensing (1720).

According to an embodiment, the UE 310 may perform a communication operation using time and frequency resources other than the time and frequency resources allocated for sensing (1730). For example, the UE 310 may receive a communication signal (DL communication signal) through the PDSCH using the time and frequency resources allocated for DL communication different from the time and frequency resources allocated for sensing. For example, the UE 310 may receive the DL communication signal in the OFDM symbol(s) having the OFDM index allocated for DL communication, which is different from the index of the OFDM symbol allocated for sensing.

Meanwhile, according to an embodiment, some of the above-described operations 1 to 4 may be omitted, and/or additional operations may be further performed. Further, the operations may be performed in a different order from the illustrated order, or multiple operations may be performed simultaneously.

Meanwhile, in FIG. 17, for convenience of description, a procedure between the base station 320 and one UE 310 has been described as an example, but embodiments are not limited thereto. For example, a plurality of UEs may be connected to the base station 320, and in this case, each UE may perform the same procedure as the procedure between the base station 320 and the UE 310 with the base station 320.

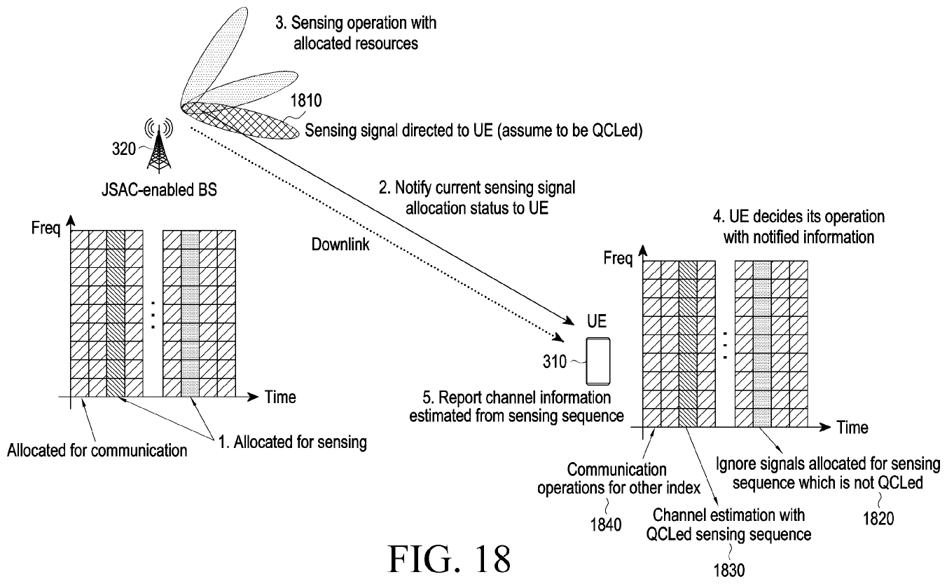

FIG. 18 illustrates an example of a downlink (DL) communication operation of a UE in a JCAS system according to an embodiment of the present disclosure.

In the embodiment of FIG. 18, unlike the embodiment of FIG. 17, it is assumed that the sensing sequence may be used for channel estimation (e.g., DL channel estimation).

Hereinafter, a DL communication operation of a UE in a JCAS system is exemplarily described with reference to FIG. 18.

Referring to FIG. 18, in operation 1, the base station 320 may allocate resources for sensing. For example, the base station 320 may allocate time and frequency resources for sensing (or sensing signal). Further, the base station 320 may allocate resources for communication. For example, the base station 320 may allocate time and frequency resources for communication (or communication signals). As illustrated in FIG. 18, resources allocated for sensing and resources allocated for communication may not overlap.

In operation 2, the base station 320 may transmit sensing configuration information including information about resource allocation for sensing (sensing resource allocation information), sensing sequence information (sensing sequence configuration), beam information, and/or QCL notification information to the UE 310. As an embodiment, the sensing resource allocation information may include information about time and frequency resources for sensing (or sensing signal) allocated in operation 1. Accordingly, the UE 310 may be notified of a current sensing signal allocation status for the sensing signal.

According to an embodiment, the base station 320 may transmit, to the UE 310, communication configuration information including information about resource allocation for DL communication (DL communication resource allocation information), together with sensing configuration information or separately. In an embodiment, the communication resource allocation information may include information about time and frequency resources for the communication (or communication signal) allocated in operation 1. Accordingly, the UE 310 may be notified of the current resource allocation status for the communication signal.

In operation 3, the base station 320 may perform a sensing operation using resources (e.g., time and frequency resources) allocated for sensing. For example, the base station 320 may transmit a sensing signal using time and frequency resources allocated for sensing. As an embodiment, the base station 320 may transmit the sensing signal through at least one beam. For example, the base station 320 may transmit a sensing signal directed to the UE 310 through the beam 1810 directed toward the UE 310. The base station 320 may receive a reflection (reflection signal) of the sensing signal reflected from the target (e.g., the UE 310 or the target 330 of FIG. 3) and may obtain sensing data and/or a sensing result based on the reflection signal.

According to an embodiment, the base station 320 may perform a communication operation using resources (e.g., time and frequency resources) allocated for communication. For example, the base station 320 may transmit a communication signal (DL communication signal) through the PDSCH using the time and frequency resources allocated for DL communication. As an embodiment, the base station 320 may transmit a DL communication signal through at least one beam. For example, a communication signal (e.g., a communication signal transmitted through a PDSCH) directed to the UE 310 may be transmitted through a beam 1810 directed toward the UE 310. As an embodiment, the sensing signal and the communication signal (or PDSCH) transmitted through the beam 1810 may be QCLed.

In operation 4, the UE 310 may determine an operation to be performed using the received/notified information (e.g., sensing resource allocation information and sensing configuration information). For example, the UE 310 may perform an operation based on sensing resource allocation information, sensing sequence information, beam information, and/or QCL information.

According to an embodiment, the UE 310 may disregard the sensing signal received through the time and frequency resources allocated for the sensing sequence that is not QCLed (1820).

According to an embodiment, the UE 310 may perform channel estimation using sensing signals received through time and frequency resources allocated for the QCLed sensing sequence (1830). The estimated channel estimation information may be used by the UE 310 for decoding the PDSCH received through the time and frequency resources allocated for DL communication.

According to an embodiment, the UE 310 may perform a communication operation using time and frequency resources other than the time and frequency resources allocated for sensing (1840). For example, the UE 310 may receive a communication signal (DL communication signal) through the PDSCH using the time and frequency resources allocated for DL communication different from the time and frequency resources allocated for sensing. For example, the UE 310 may receive, through the PDSCH, the DL communication signal in the OFDM symbol(s) having the OFDM index allocated for DL communication, which is different from the index of the OFDM symbol allocated for sensing. In this case, the channel estimation information estimated using the sensing sequence QCLed with the PDSCH may be used for decoding the PDSCH.

Meanwhile, according to an embodiment, some of the above-described operations 1 to 4 may be omitted, and/or additional operations may be further performed. Further, the operations may be performed in a different order from the illustrated order, or multiple operations may be performed simultaneously.

Meanwhile, in FIG. 18, for convenience of description, a procedure between the base station 320 and one UE 310 has been described as an example, but embodiments are not limited thereto. For example, a plurality of UEs may be connected to the base station 320, and in this case, each UE may perform the same procedure as the procedure between the base station 320 and the UE 310 with the base station 320.

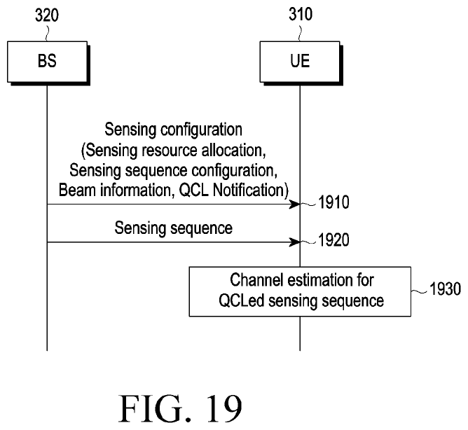

FIG. 19 illustrates an example of a procedure in which a UE performs channel estimation using a sensing sequence in a JCAS system according to an embodiment of the present disclosure.

The embodiment of FIG. 19 may be an example of the embodiment of FIG. 18. Accordingly, for the description of the embodiment of FIG. 19, the description of the embodiment of FIG. 18 may be referred to, and a duplicate description may be omitted.

In the embodiment of FIG. 19, like the embodiment of FIG. 18, it is assumed that the sensing sequence may be used for channel estimation (e.g., DL channel estimation). As an embodiment, when the sensing sequence is used for channel estimation, the sensing signal including the sensing sequence may be limited to one layer and transmitted.

Referring to FIG. 19, in operation 1910, the base station 320 may transmit sensing configuration information to the UE 310.

According to an embodiment, the base station 320 may transmit sensing configuration information to the UE 310 through higher layer signaling (e.g., SIB, RRC message and/or MAC CE) or PHY layer signaling (e.g., DCI). For example, the base station 320 may transmit an RRC message including sensing configuration information to the UE 320. For example, the base station 320 may transmit the MAC CE including the sensing configuration information to the UE 320. For example, the base station 320 may broadcast an SIB including sensing configuration information. For example, the base station 320 may transmit a DCI including sensing configuration information to the UE 320.

The sensing configuration information according to an embodiment may include resource allocation information (sensing resource allocation information), sensing sequence information (sensing sequence configuration information), beam information, and/or QCL notification information. For a description of each piece of information, reference may be made to the description of FIG. 15.

In operation 1920, the base station 320 may transmit at least one sensing sequence based on the sensing configuration information. As an embodiment, the at least one sensing sequence may include at least one of a first sensing sequence or a second sensing sequence. Here, the first sensing sequence means a sensing sequence in which the antenna port associated with the sensing signal including the corresponding sensing sequence and the antenna port associated with the communication signal transmitted through the PDSCH are QCLed (i.e., the sensing signal and the PDSCH are QCLed), and the beam indexes of the beam where the sensing signal is transmitted and the beam where the communication signal is transmitted are the same. The second sensing sequence means a sensing sequence in which the antenna port associated with the sensing signal including the corresponding sequence and the antenna port associated with the communication signal transmitted through the PDSCH are not QCLed (i.e., the sensing signal and the PDSCH are not QCLed). In the disclosure, the first sensing sequence may be referred to as a QCLed sensing sequence, and the second sensing sequence may be referred to as a non-QCLed sensing sequence.

In operation 1930, the UE 310 may receive a QCLed sensing sequence (the first sensing sequence) based on the sensing configuration information and may perform channel estimation using the QCLed sensing sequence. The UE 310 may decode the PDSCH having a QCLed relationship with the corresponding sensing sequence using the obtained channel estimation information.

The UE 310 may disregard the non-QCLed sensing sequence (second sensing sequence) based on the sensing configuration information.

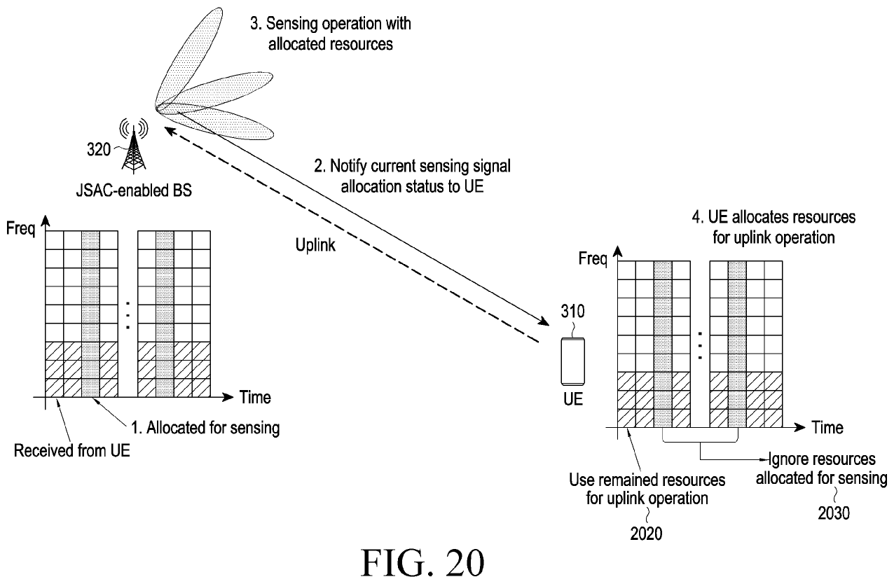

FIG. 20 illustrates an example of an uplink (UL) communication operation of a UE in a JCAS system according to an embodiment of the present disclosure.

In the case of the JCAS system, in order to perform sensing together with communication, the base station 320 needs to allocate a resource for sensing and a resource for communication and provide a notification of the allocated resource to the UE 310. In this case, unlike in a general communication system (e.g., the communication system 10 of FIG. 1), the UE 310 needs to perform an operation different from the existing communication operation in a resource area (or section) for notified sensing.

Hereinafter, a UL communication operation of a UE in a JCAS system is exemplarily described with reference to FIG. 20.

Referring to FIG. 20, in operation 1, the base station 320 may allocate resources for sensing. For example, the base station 320 may allocate time and frequency resources for sensing (or sensing signal). Further, the base station 320 may allocate resources for communication. For example, the base station 320 may allocate time and frequency resources for communication (or communication signals). As illustrated in FIG. 20, resources allocated for sensing and resources allocated for communication may not overlap.

In operation 2, the base station 320 may transmit sensing configuration information including information about resource allocation for sensing (sensing resource allocation information) to the UE 310. As an embodiment, the sensing resource allocation information may include information about time and frequency resources for sensing (or sensing signal) allocated in operation 1. Accordingly, the UE 310 may be notified of a current sensing signal allocation status for the sensing signal.

According to an embodiment, the base station 320 may transmit, to the UE 310, communication configuration information including information about resource allocation for UL communication (UL communication resource allocation information), together with sensing configuration information or separately. In an embodiment, the UL communication resource allocation information may include information about time and frequency resources for the communication (or communication signal) allocated in operation 1. Accordingly, the UE 310 may be notified of the current resource allocation status for the communication signal.

In operation 3, the base station 320 may perform a sensing operation using resources (e.g., time and frequency resources) allocated for sensing. For example, the base station 320 may transmit a sensing signal using time and frequency resources allocated for sensing. As an embodiment, the base station 320 may transmit the sensing signal through at least one beam. For example, the base station 320 may transmit a sensing signal directed to the UE 310 through the beam directed toward the UE 310. The base station 320 may receive a reflection (reflection signal) of the sensing signal reflected from the target (e.g., the UE 310 or the target 330 of FIG. 3) and may obtain sensing data and/or a sensing result based on the reflection signal.

According to an embodiment, the base station 320 may perform a communication operation using resources (e.g., time and frequency resources) allocated for communication. For example, the base station 320 may receive a communication signal (UL communication signal) through the PUSCH using the time and frequency resources allocated for UL communication.

In operation 4, the UE 310 may determine an operation to be performed using the received/notified information (e.g., sensing resource allocation information and sensing configuration information). For example, the UE 310 may perform an operation based on sensing resource allocation information.

According to an embodiment, the UE 310 may disregard sensing signals received through time and frequency resources allocated for sensing (2010).

According to an embodiment, the UE 310 may perform a communication operation using time and frequency resources other than the time and frequency resources allocated for sensing (2020). For example, the UE 310 may transmit a communication signal (UL communication signal) using the time and frequency resources allocated for UL communication, different from the time and frequency resources allocated for sensing. For example, the UE 310 may transmit the UL communication signal in the OFDM symbol(s) having the OFDM index allocated for UL communication, which is different from the index of the OFDM symbol allocated for sensing.

Meanwhile, according to an embodiment, some of the above-described operations 1 to 4 may be omitted, and/or additional operations may be further performed. Further, the operations may be performed in a different order from the illustrated order, or multiple operations may be performed simultaneously.

Meanwhile, in FIG. 20, for convenience of description, a procedure between the base station 320 and one UE 310 has been described as an example, but embodiments are not limited thereto. For example, a plurality of UEs may be connected to the base station 320, and in this case, each UE may perform the same procedure as the procedure between the base station 320 and the UE 310 with the base station 320.

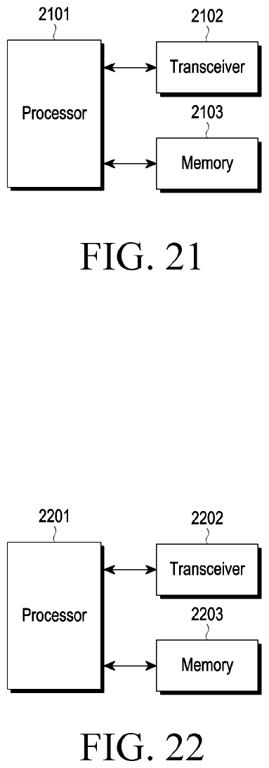

FIG. 21 illustrates an example of configuration of a UE according to an embodiment of the present disclosure.

In FIG. 21, a UE may include a processor 2101, a transceiver 2102, and memory 2103. The processor 2101, transceiver 2102, and memory 2103 of the UE of FIG. 7 may be operated according to the method(s) described above in connection with FIGS. 1 to 20. However, the components of the UE are not limited thereto. For example, the UE may include more or fewer components than the above-described components. The processor 2101, the transceiver 2102, and the memory 2103 may be implemented in the form of at least one chip.

The transceiver 2102 collectively refers to a receiver and a transmitter and may transmit and receive signals to/from a UE or another network entity. The transmitted/received signals may include at least one of control information and data. To that end, the transceiver 2102 may include an RF transmitter for frequency-up converting and amplifying signals transmitted and an RF receiver for low-noise amplifying signals received and frequency-down converting the frequency of the received signals. This is merely an embodiment of the transceiver 2102, and the components of the transceiver 2102 are not limited to the RF transmitter and the RF receiver. Further, the transceiver 2102 may receive signals through a communication scheme defined in the 3GPP standard, output the signals to the processor 2101, and transmit the signals output from the processor 2101. Further, the transceiver 2102 may receive the signal and output the signal to the processor 2101 and transmit the signal output from the processor 2101 to another network entity through the network.

The memory 2103 may store programs and data necessary for the operation of the UE according to at least one of the embodiments of FIGS. 1 to 20. The memory 2103 may store control information and/or data that is included in the signal obtained by the UE. The memory 2103 may include a storage medium, such as ROM, RAM, hard disk, CD-ROM, and DVD, or a combination of storage media.

The processor 2101 may control a series of processes so that the UE may operate according to at least one of the embodiments of FIGS. 1 to 20. The processor 2101 may include at least one processor.

According to an embodiment, the UE (or the processor 2101 of the UE) may receive sensing configuration information for a sensing operation from the base station.

According to an embodiment, the UE (or the processor 2101 of the UE) may perform a communication operation based on the sensing configuration information.

As an embodiment, the sensing configuration information includes information of a first sensing signal and a second sensing signal for the sensing operation, the second sensing signal being reflected from a target based on the sensing configuration information and the first sensing signal.

As an embodiment, the sensing configuration information may include resource allocation information for the sensing operation.

As an embodiment, the resource allocation information for the sensing operation includes time resource allocation information for the sensing operation and frequency resource allocation information for the sensing operation.

As an embodiment, the frequency resource allocation information includes start resource element (RE) index information, for the continuous frequencies, indicating an index of a start RE and end RE index information indicating an index of an end RE.

According to an embodiment, the UE (or the processor 2101 of the UE) may identify the resource allocated for the sensing operation based on the resource allocation information and disregard the signal received through the identified resource.

According to an embodiment, the UE (or the processor 2101 of the UE) may identify the resource allocated for sensing based on the information about resource allocation, receive a downlink communication signal through a resource other than the identified resource, and transmit an uplink communication signal through a resource other than the identified resource.

As an embodiment, the sensing configuration information may further include QCL notification information indicating the quasi co-location (QCL) relationship between the sensing signal and the downlink data channel and beam information about the sensing signal, and the QCL notification information and the beam information may be used by the UE for channel estimation.

According to an embodiment, the UE (or the processor 2101 of the UE) may identify the resource allocated for sensing based on the information about resource allocation and perform channel estimation using the sensing signal received through the identified resource based on the QCL notification information and the beam information.

FIG. 22 illustrates an example of configuration of a base station according to an embodiment of the present disclosure.

According to an embodiment, the base station may be a transmitting role TRP, a receiving role TRP, or a CU.

In FIG. 22, a base station may include a processor 2201, a transceiver 2202, and memory 2203. The processor 2201, transceiver 2202, and memory 2203 of the base station may be operated according to the method(s) described above in connection with FIGS. 1 to 20. However, the components of the base station are not limited thereto. For example, the base station may include more or fewer components than the above-described components. The processor 2201, the transceiver 2202, and the memory 2203 may be implemented in the form of at least one chip.

The transceiver 2202 collectively refers to a receiver and a transmitter and may transmit and receive signals to/from a UE or another network entity. The transmitted/received signals may include at least one of control information and data. To that end, the transceiver 2202 may include an RF transmitter for frequency-up converting and amplifying signals transmitted and an RF receiver for low-noise amplifying signals received and frequency-down converting the frequency of the received signals. This is merely an embodiment of the transceiver 2202, and the components of the transceiver 2202 are not limited to the RF transmitter and the RF receiver. Further, the transceiver 2202 may receive signals through a communication scheme defined in the 3GPP standard, output the signals to the processor 2201, and transmit the signals output from the processor 2201. Further, the transceiver 2202 may receive the signal and output the signal to the processor 2201 and transmit the signal output from the processor 2201 to another network entity through the network.

The memory 2203 may store programs and data necessary for the operation of the base station according to at least one of the embodiments of FIGS. 1 to 20. The memory 2203 may store control information and/or data that is included in the signal obtained by the base station. The memory 2203 may include a storage medium, such as ROM, RAM, hard disk, CD-ROM, and DVD, or a combination of storage media.

The processor 2201 may control a series of processes so that the base station may operate according to at least one of the embodiments of FIGS. 1 to 20. The processor 2201 may include at least one processor.

According to an embodiment, the base station (or the processor 2201 of the base station) may transmit sensing configuration information for a sensing operation to the UE.

According to an embodiment, the base station (or the processor 2201 of the base station) may transmit a first sensing signal for the sensing operation based on the sensing configuration information.

According to an embodiment, the base station (or the processor 2201 of the base station) may receive a second sensing signal reflected from the target based on the sensing configuration information and obtain sensing data based on the second sensing signal. As an embodiment, the sensing configuration information may include resource allocation information for the sensing operation.

As an embodiment, the resource allocation information includes time resource allocation information for the sensing operation and frequency resource allocation information for the sensing, and the frequency resource allocation information identifies continuous frequencies for the sensing operation.

As an embodiment, the frequency resource allocation information includes start resource element (RE) index information, for the continuous frequencies, indicating an index of a start RE and end RE index information indicating an index of an end RE.

As an embodiment, the sensing configuration information may further include information about a transmission period of the sensing signal and information about a transmission offset where the sensing signal is transmitted within the transmission period. The transmission period and the transmission offset may be set on a per-slot basis.

As an embodiment, the sensing configuration information further includes transmission period information of the first sensing signal and transmission offset information where the first sensing signal is transmitted within a transmission period based on the transmission period information, and the transmission period and a transmission offset are configured based on a per-slot basis.

According to an embodiment, the base station (or the processor 2201 of the base station) may, in case that the transmission mode is identified as periodic transmission mode, transmit the first sensing signal periodically based on the transmission period information and the transmission offset information.

According to an embodiment, the base station (or the processor 2201 of the base station) may, in case that the transmission mode is identified as the semi-persistent transmission mode, transmit a semi-persistent start trigger to the UE and transmit a semi-persistent stop trigger to the UE.

According to an embodiment, the base station (or the processor 2201 of the base station) may transmit, based on the transmission period information and the transmission offset information, the first sensing signal at a time when the semi-persistent stop trigger is transmitted from a time when the semi-persistent start trigger is transmitted.

According to an embodiment, the base station (or the processor 2201 of the base station) may, in case that the transmission mode is identified as the aperiodic transmission mode, transmit an aperiodic start trigger and aperiodic offset information to the UE.

According to an embodiment, the base station (or the processor 2201 of the base station) may transmit the first sensing signal based on information indicating the number of accumulated orthogonal frequency division multiplexing (OFDM) symbols used for Doppler processing, the transmission period information, and the transmission offset information, at a time away from a time when the aperiodic start trigger is transmitted by an offset indicated by the aperiodic offset information. As an embodiment, the information indicating the number of the accumulated OFDM symbols may be included in the sensing configuration information.

According to an embodiment, the base station (or the processor 2201 of the base station) may broadcast set identifier (ID) information indicating an ID of a sensing parameter set including a plurality of sensing parameters, using a system information block (SIB).

According to an embodiment, the base station (or the processor 2201 of the base station) may broadcast a sensing parameter bitmap including bitmap data associated with a setting value for a plurality of sensing parameters, using an SIB.

According to an embodiment, the sensing configuration information may further include QCL notification information indicating the quasi co-location (QCL) relationship between the sensing signal and the downlink data channel and beam information about the sensing signal, and the QCL notification information and the beam information may be used by the UE for channel estimation.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Meanwhile, although specific embodiments of the disclosure have been described above, various changes may be made thereto without departing from the scope of the disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed:

1. A method by a base station in a wireless communication system, the method comprising:
transmitting, to a user equipment (UE), sensing configuration information for a sensing operation;
transmitting a first sensing signal for the sensing operation based on the sensing configuration information; and
receiving a second sensing signal reflected from a target based on the sensing configuration information and obtaining sensing data based on the second sensing signal,
wherein the sensing configuration information includes resource allocation information for the sensing operation.

2. The method of claim 1, wherein the resource allocation information includes time resource allocation information for the sensing operation and frequency resource allocation information for the sensing, and
wherein the frequency resource allocation information identifies continuous frequencies for the sensing operation.

3. The method of claim 2, wherein the frequency resource allocation information includes start resource element (RE) index information, for the continuous frequencies, indicating an index of a start RE and end RE index information indicating an index of an end RE.

4. The method of claim 1, wherein the sensing configuration information further includes transmission period information of the first sensing signal and transmission offset information in which the first sensing signal is transmitted within a transmission period based on the transmission period information, and wherein the transmission period and a transmission offset are configured based on a per-slot basis.

5. The method of claim 4, wherein the sensing configuration information further includes transmission mode information indicating a transmission mode of the first sensing signal, and
wherein the transmission mode comprises one of a periodic transmission mode, a semi-persistent transmission mode, or an aperiodic transmission mode.

6. The method of claim 5, wherein, in case that the transmission mode is identified as the periodic transmission mode, transmitting the first sensing signal for the sensing operation comprises:
transmitting the first sensing signal periodically based on the transmission period information and the transmission offset information.

7. The method of claim 5, in case that the transmission mode is identified as the semi-persistent transmission mode, further comprising:
transmitting, to the UE, a semi-persistent start trigger; and
transmitting, to the UE, a semi-persistent stop trigger,
wherein transmitting the first sensing signal comprises:
transmitting, based on the transmission period information and the transmission offset information, the first sensing signal at a time when the semi-persistent stop trigger is transmitted from a time when the semi-persistent start trigger is transmitted.

8. A method by a user equipment (UE) in a wireless communication system, the method comprising:
receiving, from a base station, sensing configuration information for a sensing operation; and
performing a communication operation based on the sensing configuration information,
wherein the sensing configuration information includes information of a first sensing signal and a second sensing signal for the sensing operation, the second sensing signal being reflected from a target based on the sensing configuration information and the first sensing signal, and
wherein the sensing configuration information includes resource allocation information for the sensing operation.

9. The method of claim 8, wherein the resource allocation information for the sensing operation includes time resource allocation information for the sensing operation and frequency resource allocation information for the sensing operation, and
wherein the frequency resource allocation information identifies continuous frequencies for the sensing operation, and
wherein the frequency resource allocation information includes start resource element (RE) index information, for the continuous frequencies, indicating an index of a start RE and end RE index information indicating an index of an end RE.

10. The method of claim 8, wherein performing the communication operation includes
identifying a resource allocated for the sensing operation based on the resource allocation information and disregarding a signal received through the identified resource.

11. A base station in a wireless communication system, the base station comprising:
a transceiver; and
at least one processor coupled to the transceiver and configured to:
transmit, to a user equipment (UE), sensing configuration information for a sensing operation; and
transmit a first sensing signal for the sensing operation based on the sensing configuration information; and receive a second sensing signal reflected from a target based on the sensing configuration information and obtain sensing data based on the second sensing signal,
wherein the sensing configuration information includes resource allocation information for the sensing operation.

12. The base station of claim 11, wherein the resource allocation information includes time resource allocation information for the sensing operation and frequency resource allocation information for the sensing, and
wherein the frequency resource allocation information identifies continuous frequencies for the sensing operation.

13. The base station of claim 12, wherein the frequency resource allocation information includes start resource element (RE) index information, for the continuous frequencies, indicating an index of a start RE and end RE index information indicating an index of an end RE.

14. The base station of claim 11, wherein the sensing configuration information further includes transmission period information of the first sensing signal and transmission offset information where the first sensing signal is transmitted within a transmission period based on the transmission period information, and
wherein the transmission period and a transmission offset are configured based on a per-slot basis.

15. The base station of claim 14, wherein the sensing configuration information further includes transmission mode information indicating a transmission mode of the first sensing signal, and wherein the transmission mode comprises one of a periodic transmission mode, a semi-persistent transmission mode, or an aperiodic transmission mode.

16. The base station of claim 15, wherein, in case that the transmission mode is identified as periodic transmission mode, the at least one processor is further configured to:
transmit the first sensing signal periodically based on the transmission period information and the transmission offset information.

17. The base station of claim 15, wherein, in case that the transmission mode is identified as the semi-persistent transmission mode, the at least one processor is further configured to:
transmit, to the UE, a semi-persistent start trigger,
transmit, to the UE, a semi-persistent stop trigger, and
transmit, based on the transmission period information and the transmission offset information, the first sensing signal at a time when the semi-persistent stop trigger is transmitted from a time when the semi-persistent start trigger is transmitted.

18. A user equipment (UE) in a wireless communication system, the UE comprising:
a transceiver; and
at least one processor coupled to the transceiver and configured to:
receive, from a base station, sensing configuration information for a sensing operation; and
perform a communication operation based on the sensing configuration information,
wherein the sensing configuration information includes information of a first sensing signal and a second sensing signal for the sensing operation, the second sensing signal being reflected from a target based on the sensing configuration information and the first sensing signal, and
wherein the sensing configuration information includes resource allocation information for the sensing operation.

19. The UE of claim 18, wherein the resource allocation information for the sensing operation includes time resource allocation information for the sensing operation and frequency resource allocation information for the sensing operation, and
wherein the frequency resource allocation information identifies continuous frequencies for the sensing operation, and
wherein the frequency resource allocation information includes start resource element (RE) index information, for the continuous frequencies, indicating an index of a start RE and end RE index information indicating an index of an end RE.

20. The UE of claim 18, wherein at least one processor is further configured to identify a resource allocated for the sensing operation based on the resource allocation information and disregarding a signal received through the identified resource.
